(19) United States
(12) Patent Application Publication
(10) Pub. No.: US 2015/0113458 A1
(43) Pub. Date: Apr. 23, 2015

(54) METHOD AND APPARATUS FOR PROVIDING A USER INTERFACE FOR PRESENTING ROUTING SEGMENTS

(71) Applicant: HERE Global B.V., Veldhoven (NL)

(72) Inventors: Thomas MANN, Berlin (DE); Justus BROWN, Berlin (DE); Katharina GORMANNS, Veldhoven (NL); Lejla RESIC, Berlin (DE); Florentina ARSINTE, Berlin (DE); Sascha KOLEWA, Veldhoven (NL); Virva AUVINEN, Berlin (DE)

(73) Assignee: HERE Global B.V., Veldhoven (NL)

(21) Appl. No.: 14/058,967

(22) Filed: Oct. 21, 2013

(51) Int. Cl. G06F 3/0485; G06F 3/0484; G06F 3/0481

(52) U.S. Cl. CPC G06F 3/0485; G06F 3/04817; G06F 3/04842
USPC 715/771

(57) ABSTRACT

An approach is provided for causing, at least in part, a presentation of a first representation of one or more segments of routing information in at least one first user interface element of a user interface. Then, the navigation platform causes, at least in part, a presentation of a second representation of the one or more segments of routing information in at least one second user interface element of the user interface. Subsequently, the navigation platform determines one or more interactions with the at least one first user interface element to cause, at least in part, a presentation of one or more other segments of the routing information. Ultimately, the navigation platform causes, at least in part, an updating of the at least one second user interface element based, at least in part, on the presentation of the one or more other segments of the routing information.

### BACKGROUND

Service providers and device manufacturers (e.g., wireless, cellular, etc.) are continually challenged to deliver value and convenience to consumers by, for example, providing compelling network services as well as a user-friendly device. One area of interest has been providing device users with on demand access to user interface elements of a location based services for navigational purposes. Needless to mention, user convenience is one of the foundation for creating a successful user interface and a positive user experience. However, navigational user interfaces have been cumbersome in terms of user interaction, either the display size is constrained making it difficult to view on a small navigational screen or the display fails to attract user attention on important or actionable elements. Accordingly, service providers and device manufacturers are challenged to develop new mechanisms for presenting routing information in the most convenient manner for the users.

### Some Example Embodiments

Therefore, there is a need for an approach for causing a presentation of one or more segments of routing information in multiple user interface elements of a user interface for user selection, and causing an update of the multiple user interface elements based on the selection.

According to one embodiment, a method comprises causing, at least in part, a presentation of a first representation of one or more segments of routing information in at least one first user interface element of a user interface. The method also comprises causing, at least in part, a presentation of a second representation of the one or more segments of routing information in at least one second user interface element of the user interface. The method further comprises determining one or more interactions with the at least one first user interface element to cause, at least in part, a presentation of one or more other segments of the routing information. The method also comprises causing, at least in part, an updating of the at least one second user interface element based, at least in part, on the presentation of the one or more other segments of the routing information.

According to another embodiment, an apparatus comprises at least one processor, and at least one memory including computer program code for one or more computer programs, the at least one memory and the computer program code configured to, with the at least one processor, cause, at least in part, the apparatus to cause, at least in part, a presentation of a first representation of one or more segments of routing information in at least one first user interface element of a user interface. The apparatus is also caused to cause, at least in part, a presentation of a second representation of the one or more segments of routing information in at least one second user interface element of the user interface. The apparatus is further caused to cause a determination of one or more interactions with the at least one first user interface element to cause, at least in part, a presentation of one or more other segments of the routing information. The apparatus is also caused to cause, at least in part, an updating of the at least one second user interface element based, at least in part, on the presentation of the one or more other segments of the routing information.

According to another embodiment, a computer-readable storage medium carries one or more sequences of one or more instructions which, when executed by one or more processors, cause, at least in part, an apparatus to cause, at least in part, a presentation of a first representation of one or more segments of routing information in at least one first user interface element of a user interface. The apparatus is also caused to cause, at least in part, a presentation of a second representation of the one or more segments of routing information in at least one second user interface element of the user interface. The apparatus is further caused to cause a determination of one or more interactions with the at least one first user interface element to cause, at least in part, a presentation of one or more other segments of the routing information. The apparatus is also caused to causes, at least in part, an updating of the at least one second user interface element based, at least in part, on the presentation of the one or more other segments of the routing information.

According to another embodiment, an apparatus comprises means for causing, at least in part, a presentation of a first representation of one or more segments of routing information in at least one first user interface element of a user interface. The apparatus also comprises means for causing, at least in part, a presentation of a second representation of the one or more segments of routing information in at least one second user interface element of the user interface. The apparatus further comprises means for determining one or more interactions with the at least one first user interface element to cause, at least in part, a presentation of one or more other segments of the routing information. The apparatus also comprises means for causing, at least in part, an updating of the at least one second user interface element based, at least in part, on the presentation of the one or more other segments of the routing information.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing the method of any of originally filed claims 1-10, 21-30, and 46-48.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of causing a presentation of one or more segments of routing information in multiple user interface elements of a user interface for user selection, and causing an update of the multiple user interface elements based on the selection, according to one embodiment;

FIG. 2 is a diagram of the components of the navigation platform 109, according to one embodiment;

FIG. 3 is a diagram of the components of the view generation module 205, according to one embodiment;

FIG. 4 is a diagram of the components of the geographic database 111, according to one embodiment;

FIG. 5 is a flowchart of a process for causing a presentation of one or more segments of routing information in multiple user interface elements of a user interface for user selection, and causing an update of the multiple user interface elements based on the selection, according to one embodiment;

FIG. 6 is a flowchart of a process for determining a position of at least one device to cause, at least in part, a presentation of time-based information and/or color based information as a visual guidance for identifying one or more segments of routing information, according to one embodiment;

FIG. 7 is a flowchart of a process for determining changes in the location information for at least one user and causing a presentation of an updated segment of routing information in at least one first user interface element and/or at least one second user interface element, according to one embodiment;

FIG. 8 is a flowchart of a process for causing a transition between routing segments and a notification based, at least in part, on the routing information, according to one embodiment;

FIGS. 9-12H are diagrams of user interfaces utilized in the processes of FIG. 3, according to various embodiments;

FIG. 13 is a diagram of hardware that can be used to implement an embodiment of the invention;

FIG. 14 is a diagram of a chip set that can be used to implement an embodiment of the invention; and

FIG. 15 is a diagram of a mobile terminal (e.g., handset) that can be used to implement an embodiment of the invention.

### DESCRIPTION OF SOME EMBODIMENTS

Examples of a method, apparatus, and computer program for causing a presentation of one or more segments of routing information in multiple user interface elements of a user interface for user selection, and causing an update of the multiple user interface elements based on the selection are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

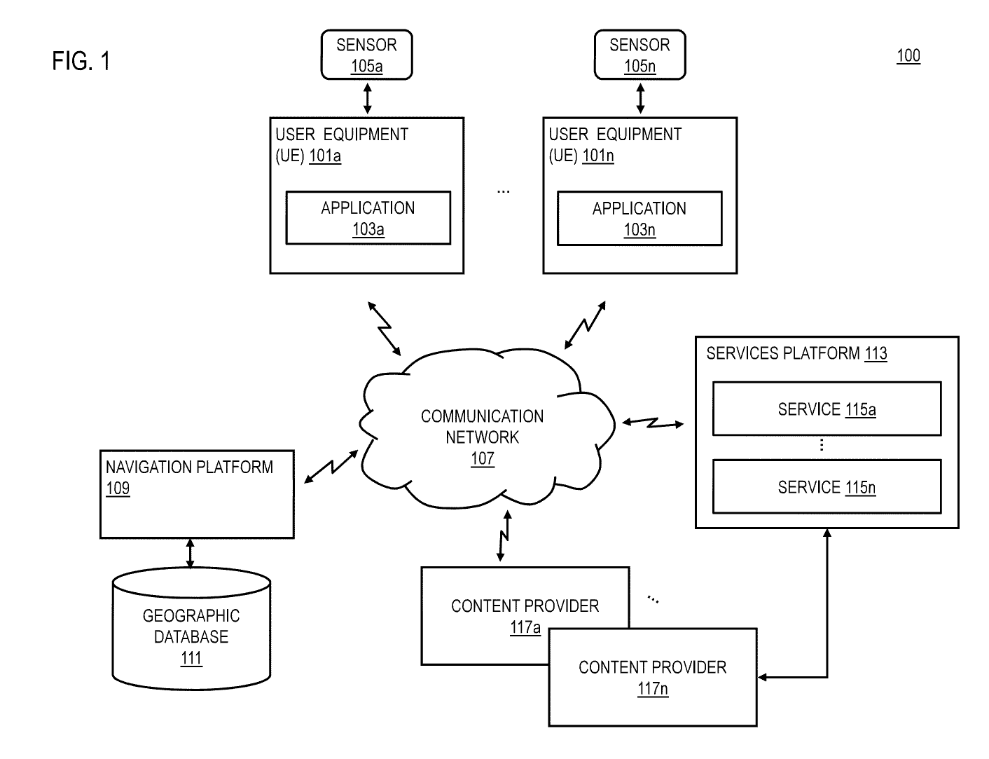

FIG. 1 is a diagram of a system capable of causing a presentation of one or more segments of routing information in multiple user interface elements of a user interface for user selection, and causing an update of the multiple user interface elements based on the selection, according to one example embodiment. As noted previously, device users regularly rely on routing applications and corresponding services to access information regarding a travel route. By way of such tools, users may access maps for detailing the route, navigation directions, information regarding various streets (e.g., location anchors) they may encounter, etc. Typically, the routing option is visually depicted as various lines or objects presented to map. As noted, navigational services have gain ubiquitous adoption by users, but that the conventional interfaces can be rather burdensome. Such interfaces can lack an intuitive interface for inputting information and viewing information.

To address this problem, a system 100 of FIG. 1 introduces the capability to provide navigational services that include a user interface that offers features that are easy to operate and view. Thus, the system 100 provides a user with the ability to fully utilize the navigational services offered by a service provider, wherein multiple user interface elements of a user interface displays one or more segments of routing information for user interaction. In one example embodiment, the virtual point between the at least one first user interface element and the at least one second user interface element may act as a pivot. In one scenario, at least one user interaction with the at least one second user interface element may cause an update in the representation of one or more segments of routing information in at least one first user interface element of a user interface. As shown in FIG. 1, the system 100 comprises user equipment (UEs) 101a-101n (collectively referred to as UE 101) that may include or be associated with applications 103a-103n (collectively referred to as applications 103) and sensors 105a-105n (collectively referred to as sensors 105). In one embodiment, the UE 101 has connectivity to the navigation platform 109 via the communication network 107.

By way of example, the UE 101 is any type of mobile terminal, fixed terminal, or portable terminal including a mobile handset, station, unit, device, multimedia computer, multimedia tablet, Internet node, communicator, desktop computer, laptop computer, notebook computer, netbook computer, tablet computer, personal communication system (PCS) device, personal navigation device, personal digital assistants (PDAs), audio/video player, digital camera/camcorder, positioning device, television receiver, radio broadcast receiver, electronic book device, game device, or any combination thereof, including the accessories and peripherals of these devices, or any combination thereof. It is also contemplated that the UE 101 can support any type of interface to the user (such as “wearable” circuitry, etc.). In one embodiment, the UE 101 may be included within the one or more vehicles.

By way of example, the applications 103 may be any type of application that is executable at the UE 101, such as, location-based services (e.g., providing proximity information), messaging applications (e.g., SMS, MMS, etc.), an Internet browser, media applications (e.g., music and/or video streaming, photo exchange, etc.), social networking applications, etc. In one embodiment, the UE 101 may use applications 103 to convey navigation services to one or more users. In another embodiment, the applications 103 may aid the navigation platform 109 in causing, at least in part, a presentation of multiple display of one or more map features which includes a map view and/or an information view based, at least in part, on a determination of an input for specifying one or more map features for at least one destination.

By way of example, the sensors 105 may be any type of sensor. In one embodiment, the sensors 105 may include one or more sensors that may assist the navigation platform 109 to determine route information for at least one destination. In one scenario, the sensors 105 may include location sensors (e.g., GPS), light sensors, oriental sensors augmented with height sensor and acceleration sensor, tilt sensors, tactile sensors, pressure sensors, audio sensors (e.g., microphone), or receivers for different short-range communications (e.g., Bluetooth, WiFi, etc.).

The communication network 107 of system 100 includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth®, Internet Protocol (IP) data casting, satellite, mobile ad-hoc network (MANET), and the like, or any combination thereof.

In one embodiment, the navigation platform 109 may be a platform with multiple interconnected components. The navigation platform 109 may include multiple servers, intelligent networking devices, computing devices, components and corresponding software for causing a presentation of multiple representation of one or more segments of routing information in one or more user interface elements of a user interface. In one embodiment, the navigation platform 109 causes, at least in part, a presentation of a first representation of one or more segments of routing information in at least one first user interface element of a user interface. The navigation platform 109 also causes, at least in part, a presentation of a second representation of the one or more segments of routing information in at least one second user interface element of the user interface. Consequently, the navigation platform 109 determines one or more interactions with the at least one first user interface element to cause, at least in part, a presentation of one or more other segments of the routing information. Accordingly, the navigation platform 109 causes, at least in part, an updating of the at least one second user interface element based, at least in part, on the presentation of the one or more other segments of the routing information. In one embodiment, the at least one user interface element, the at least one second user interface, or a combination thereof is a sub-window of the user interface element.

In one example embodiment, a UE 101 may receive a request to render user interface elements of a location-based service, whereby the navigation platform 109 may cause, at least in part, an initiation of a presentation of user interface elements on at least one UE 101. In one embodiment, the user interface elements may include a display screen depicting a user selectable options menu corresponding with service functions offered by the location-based service. In another example embodiment, the navigation platform 109 may process and/or facilitate a processing of an input to determine one or more interactions with the user interface elements of a location-based service. Subsequently, the navigation platform 109 causes, at least in part, a rendering of one or more navigation segments of the at least one map features in the user interface elements based, at least in part, on the one or more interactions. The one or more interactions include, at least in part, a touch-based interaction, a gesture-based interaction, or a combination thereof. In one embodiment, the presentation of the one or more navigation segments includes walking directions for pedestrian navigation, driving directions for vehicle navigation, transit directions, bicycling directions, or a combination thereof. In another embodiment, the navigation platform 109 reviews the planned navigation and provides the at least one user with recent updates, if any.

In one embodiment, the navigation platform 109 may include or have access to the geographic database 111 to access or store any kind of data associated with POI, such as historical user information, location proximity information, temporal information, contextual information, etc. Data stored in the geographic database 111 may, for instance, be provided by the UE 101, the services platform 113, one or more services 115a-115n (or services 115), or one or more content providers 117a-117n (or content providers 117).

The services platform 113 may include any type of service. By way of example, the services platform 113 may include mapping services, navigation services, travel planning services, social networking services, content (e.g., audio, video, images, etc.) provisioning services, application services, storage services, contextual information determination services, location based services, information (e.g., weather, news, etc.) based services, etc. In one embodiment, the services platform 113 may interact with the UE 101, the navigation platform 109 and the content providers 117 to supplement or aid in the processing of the content information. In other embodiments, the services platform 113, the services 115, the applications 103, etc. may be used to allow the users of UE 101 to cause a presentation of one or more segments of routing information in one or more user interface elements of a user interface.

By way of example, services 115 may be an online service that reflects interests and/or activities of users. In one scenario, the services 115 provide representations of each user (e.g., a profile), his/her social links, and a variety of additional information. The services 115 allow users to share location information, activities information, contextual information, and interests within their individual networks, and provides for data portability. The services 115 may additionally assist in providing the navigation platform 109 with travel information of the one or more geo-routes and/or location anchors, etc.

The content providers 117 may provide content to the UE 101, the navigation platform 109, and the services 115 of the services platform 113. The content provided may be any type of content, such as textual content, audio content, video content, image content, etc. In one embodiment, the content providers 117 may provide content that may supplement content of the applications 103, the sensors 105, or a combination thereof. By way of example, the content providers 117 may provide content that may aid in the processing of the content information associated with POI to determine route information. In one embodiment, the content providers 117 may also store content associated with the UE 101, the navigation platform 109, and the services 115 of the services platform 113. In another embodiment, the content providers 117 may manage access to a central repository of data, and offer a consistent, standard interface to data, such as a repository of users' navigational data content.

By way of example, the UE 101, the navigation platform 109, the services platform 113, and the content providers 117 communicate with each other and other components of the communication network 107 using well known, new or still developing protocols. In this context, a protocol includes a set of rules defining how the network nodes within the communication network 107 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

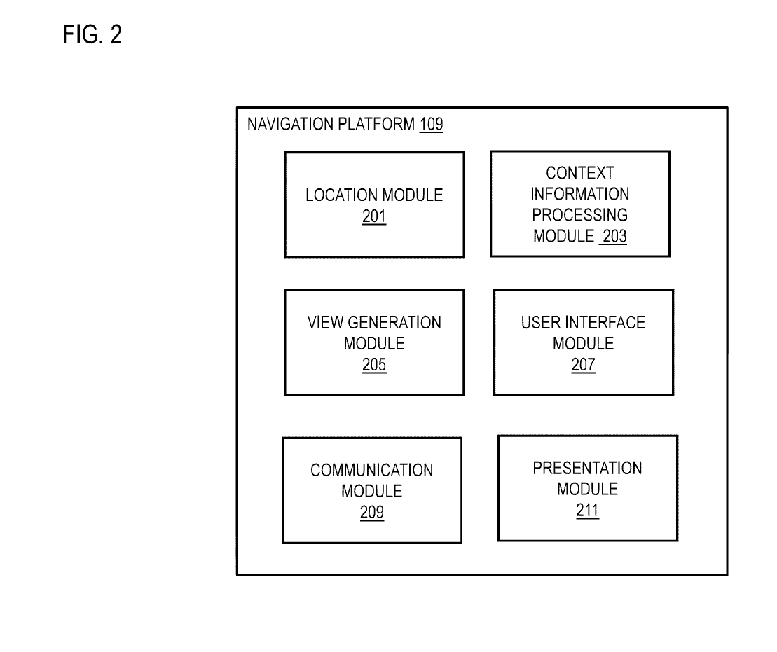

FIG. 2 is a diagram of the components of the navigation platform 109, according to one example embodiment. By way of example, the navigation platform 109 includes one or more components for causing a presentation of one or more segments of routing information in multiple user interface elements of a user interface for user selection, and causing an update of the multiple user interface elements based on the selection, according to one embodiment. It is contemplated that the functions of these components may be combined in one or more components or performed by other components of equivalent functionality. In this embodiment, the navigation platform 109 includes a location module 201, the context information processing module 203, the view generation module 205, the user interface module 207, the communication module 209 and the presentation module 211.

In one embodiment, the location module 201 can determine the user's location. The user's location can be determined by a triangulation system such as GPS, assisted-GPS (A-GPS), Cell of Origin, or other location extrapolation technologies, as well as proximity location indicators, such as a signal from a wireless local area network (WLAN), a Bluetooth® system, or the like. Standard GPS and A-GPS systems can use satellites to pinpoint the location of a UE 101. A Cell of Origin system can be used to determine the cellular tower that a cellular UE 101 is synchronized with. This information provides a coarse location of the UE 101 because the cellular tower can have a unique cellular identifier (cell-ID) that can be geographically mapped. The location module 201 may also utilize multiple technologies to detect the location of the UE 101. For instance, a GPS system may narrow the location of the UE 101 to a building and a WLAN signal can determine UE 101 locations within the building. In one embodiment, the location module 201 aids the navigation platform 109 to determine a change in the location information, thereby causing a transition from one navigation segment to another navigation segment. In another embodiment, the location module 201 assists the navigation platform 109 in causing a notification to at least one user upon determination that the user has reached at least one destination.

In one embodiment, the context information processing module 203 receives context information as gathered by the sensors 105 of respective UE 101 and/or the geographic database 111 and/or services 115. Once received, the context information processing module 203 analyzes the context information to determine the relative location, time, position and other information useful for generating a map in association with a specified location. Based on this determination, the context information processing module 203 triggers execution of the view generation module 205, which facilitates the querying/retrieval associated map image data from the geographic database 111 corresponding to the location. In one embodiment, the context information processing module 203 processes and/or facilitates a processing of contextual information of at least one UE 101 thereby assisting the navigation platform 109 to cause a presentation of one or more advertisements based, at least in part, on the contextual information, the location information, or a combination thereof.

In one embodiment, the view generation module 205 facilitates gathering of the various map images corresponding to a location selected via a mapping application or service. In addition, the view generation module 205 determines and/or retrieves the various map images corresponding to a specified route. It is noted, in certain embodiments, that the view generation module 205 may facilitate various image rendering, blending, merging and other compilation techniques for producing a user friendly map image.

In one embodiment, the user interface module 207 enables presentation of a graphical user interface for displaying map images in connection with a selected destination. By way of example, the user interface module 207 generates the user interface element in response to detection of an input for selection of a particular destination. As another example, the user interface module 207 enables colorful presentation and highlighting of a specific route related to the particular destination presented via the user interface. Of note, the user interface module 207 triggers execution of the various other modules, including the location module 201, and the view generation module 205 in response to user input. The user interface module 207 employs various application programming interfaces (APIs) or other function calls corresponding to the applications 103 of UE 101, thus enabling the display of graphics primitives such as menus, buttons, data entry fields, etc., for generating the user interface elements. Still further, the user interface module 207 may be configured to operate in connection with augmented reality (AR) processing techniques, wherein various different applications, graphic elements and features may interact. For example, the user interface module 207 may coordinate the presentation of augmented reality map images in conjunction with various images for a given location or in response to a selected destination. In one example embodiment, the at least one user interface element and/or the at least one second user interface may be a sub-window of the user interface element, wherein the at least one first representation of one or more segments of routing information may be updated based, at least in part, on the user interaction with the at least one second user interface element.

In one embodiment, the communication module 209 enables formation of a session over a communication network 107 between the navigation platform 109 and the services 115. By way of example, the communication module 209 executes various protocols and data sharing techniques for enabling collaborative execution between a UE 101 and the navigation platform 109 over the communication network 107.

The presentation module 211 makes a colored presentation of the map with determined routes and highlighted therein upon receiving the data from the communication module 209. The presentation module 211 may utilize the geographic database 111 and/or services 115 to determine whether the information for a route is up to date. This module obtains a set of summary statistics from other modules. Then, the module continues with generating a presentation corresponding to the destination. Subsequently, the module continues with providing a presentation of data set where the presentation could be depicted in one or more visual display units.

The above presented modules and components of the navigation platform 109 can be implemented in hardware, firmware, software, or a combination thereof. Though depicted as a separate entity in FIG. 1, it is contemplated that the navigation platform 109 may be implemented for direct operation by respective UE 101. As such, the navigation platform 109 may generate direct signal inputs by way of the operating system of the UE 101 for interacting with the applications 103. In another embodiment, one or more of the modules 201-211 may be implemented for operation by respective UEs, the navigation platform 109, or combination thereof. Still further, the navigation platform 109 may be integrated for direct operation with services 115, such as in the form of a widget or applet, in accordance with an information and/or subscriber sharing arrangement. The various executions presented herein contemplate any and all arrangements and models.

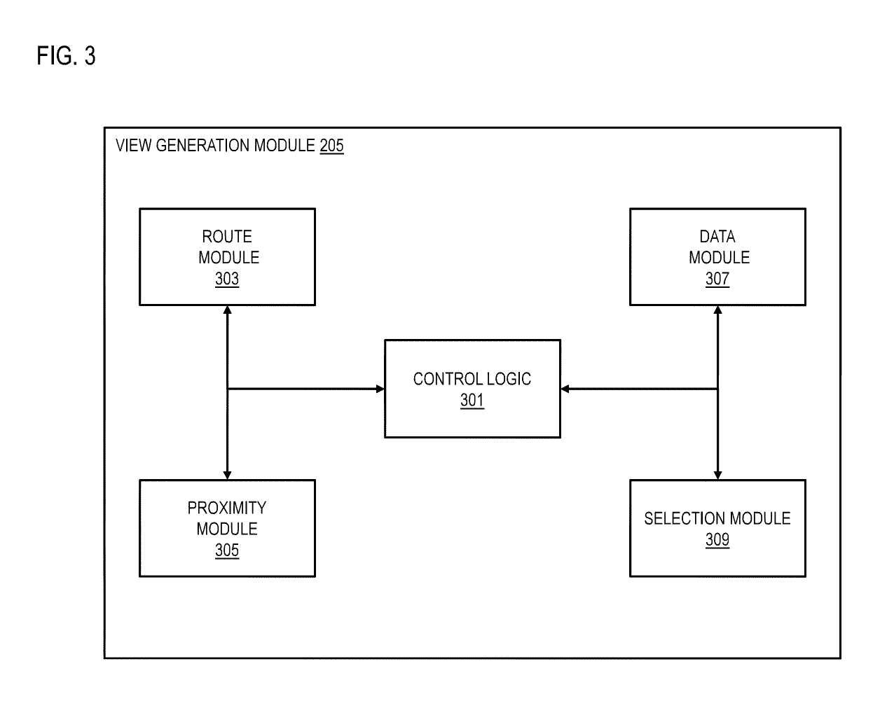

FIG. 3 is a diagram of the components of the view generation module 205, according to one example embodiment. By way of example, the view generation module 205 includes one or more components for causing a presentation of multiple displays of one or more map features which includes a map view, an information view, or a combination thereof. It is contemplated that the functions of these components may be combined in one or more components or performed by other components of equivalent functionality. In this embodiment, the view generation module 205 includes a control logic 301, the route module 303, the proximity module 305, the data module 307, and the selection module 309.

The control logic 301 executes at least one algorithm for executing functions at the presentation module 211. For example, the control logic 301 may interact with the route module 303 to receive one or more navigation segment for the at least one destination. With the one or more navigation segments the control logic 301 and the proximity module 305 may determine proximity information of one or more UE 101 to the at least one segment of the routing information. Thereafter, the control logic 301 may relay the proximity information to the location module 201 whereby the location module 201 may instruct the navigation platform 109 to cause a notification to the at least one user that he/she has reached at least one segment of the routing information.

The control logic 301 and the data module 307 may define (point of interest) POI information, while the selection module 309 may select routes and/or modes of transportation associated with the selected destination based, at least in part, on the proximity information determined by the proximity module 305. For instance, the route and/or the modes of transportation within a certain proximity threshold of one or more UE 101 may be chosen out of all the other routes and modes of transportation. For example in one scenario, the control logic 301 and the selection module 309 may determine to select the top three routes that are geographically closest to at least one destination from the location of the UE 101.

In one embodiment, the selection module 309 may interact with other modules of the navigation platform 109 to direct the one or more UE 101 to the chosen route. For example, the control logic 301 and applications 103 may work together to determine navigation guidance information to cause, at least in part, a presentation of the one or more route information. In one scenario, this may include UE 101 displaying directions on how to reach POI.

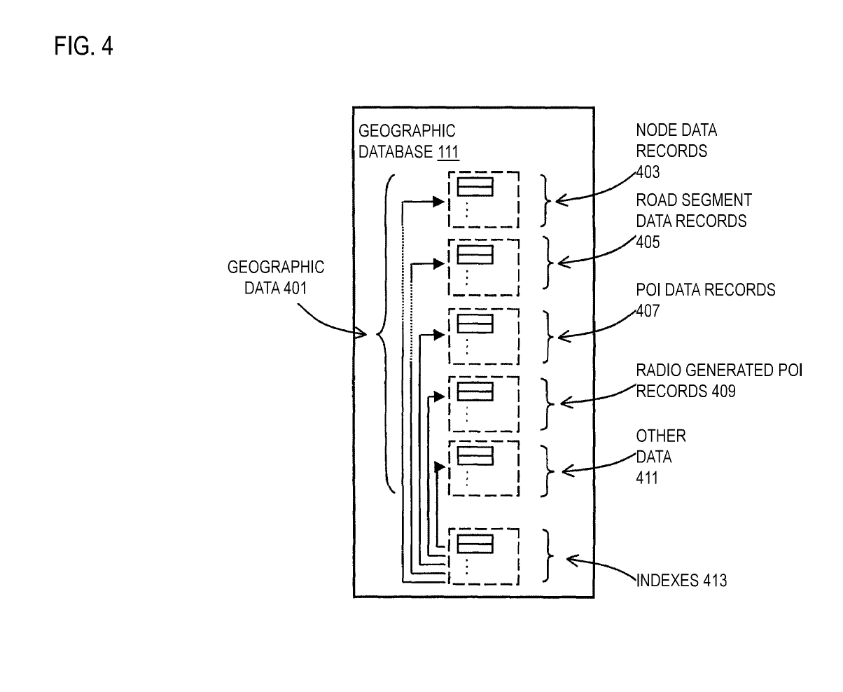

FIG. 4 is a diagram of the geographic database 111 of system 100, according to exemplary embodiments. In the exemplary embodiments, POIs and map generated POIs data can be stored, associated with, and/or linked to the geographic database 111 or data thereof. In one embodiment, the geographic database 111 includes geographic data 401 used for (or configured to be compiled to be used for) mapping and/or navigation-related services, such as for personalized route determination, according to exemplary embodiments. For example, the geographic database 111 includes node data records 403, road segment or link data records 405, POI data records 407, radio generated POI records 409, and other data records 411, for example. More, fewer or different data records can be provided. In one embodiment, the other data records 411 include cartographic (“carto”) data records, routing data, and maneuver data. One or more portions, components, areas, layers, features, text, and/or symbols of the POI or event data can be stored in, linked to, and/or associated with one or more of these data records. For example, one or more portions of the POI, event data, or recorded route information can be matched with respective map or geographic records via position or GPS data associations (such as using known or future map matching or geo-coding techniques), for example.

In exemplary embodiments, the road segment data records 405 are links or segments representing roads, streets, or paths, as can be used in the calculated route or recorded route information for determination of one or more personalized routes, according to exemplary embodiments. The node data records 403 are end points corresponding to the respective links or segments of the road segment data records 405. The road link data records 405 and the node data records 403 represent a road network, such as used by vehicles, cars, and/or other entities. Alternatively, the geographic database 111 can contain path segment and node data records or other data that represent pedestrian paths or areas in addition to or instead of the vehicle road record data, for example.

The road/link segments and nodes can be associated with attributes, such as geographic coordinates, street names, address ranges, speed limits, turn restrictions at intersections, and other navigation related attributes, as well as POIs, such as gasoline stations, hotels, restaurants, museums, stadiums, offices, automobile dealerships, auto repair shops, buildings, stores, parks, etc. The geographic database 111 can include data about the POIs and their respective locations in the POI data records 407. The geographic database 111 can also include data about places, such as cities, towns, or other communities, and other geographic features, such as bodies of water, mountain ranges, etc. Such place or feature data can be part of the POI data records 407 or can be associated with POIs or POI data records 407 (such as a data point used for displaying or representing a position of a city). In addition, the geographic database 111 can include data from radio advertisements associated with the POI data records 407 and their respective locations in the radio generated POI records 409. By way of example, a street is determined from the user interaction with the UE 101 and the content information associated with UE 101, according to the various embodiments described herein.

The geographic database 111 can be maintained by the content provider in association with the services platform 113 (e.g., a map developer). The map developer can collect geographic data to generate and enhance the geographic database 111. There can be different ways used by the map developer to collect data. These ways can include obtaining data from other sources, such as municipalities or respective geographic authorities. In addition, the map developer can employ field personnel to travel by vehicle along roads throughout the geographic region to observe features and/or record information about them, for example. Also, remote sensing, such as aerial or satellite photography, can be used.

The geographic database 111 can be a master geographic database stored in a format that facilitates updating, maintenance, and development. For example, the master geographic database 111 or data in the master geographic database 111 can be in an Oracle spatial format or other spatial format, such as for development or production purposes. The Oracle spatial format or development/production database can be compiled into a delivery format, such as a geographic data files (GDF) format. The data in the production and/or delivery formats can be compiled or further compiled to form geographic database products or databases, which can be used in end user navigation devices or systems.

For example, geographic data is compiled (such as into a platform specification format (PSF) format) to organize and/or configure the data for performing navigation-related functions and/or services, such as route calculation, route guidance, map display, speed calculation, distance and travel time functions, and other functions, by a navigation device, such as by a UE 101, for example. The navigation-related functions can correspond to vehicle navigation, pedestrian navigation, or other types of navigation. The compilation to produce the end user databases can be performed by a party or entity separate from the map developer. For example, a customer of the map developer, such as a navigation device developer or other end user device developer, can perform compilation on a received geographic database in a delivery format to produce one or more compiled navigation databases.

As mentioned above, the geographic database 111 can be a master geographic database, but in alternate embodiments, the geographic database 111 can represent a compiled navigation database that can be used in or with end user devices (e.g., UE 101) to provided navigation-related functions. For example, the geographic database 111 can be used with the end user device UE 101 to provide an end user with navigation features. In such a case, the geographic database 111 can be downloaded or stored on the end user device UE 101, such as in applications 103, or the end user device UE 101 can access the geographic database 111 through a wireless or wired connection (such as via a server and/or the communication network 107), for example.

In one embodiment, the end user device or UE 101 can be an in-vehicle navigation system, a personal navigation device (PND), a portable navigation device, a cellular telephone, a mobile phone, a personal digital assistant (PDA), a watch, a camera, a computer, and/or other device that can perform navigation-related functions, such as digital routing and map display. In one embodiment, the navigation device UE 101 can be a cellular telephone. An end user can use the device UE 101 for navigation functions such as guidance and map display, for example, and for determination of one or more personalized routes or route segments based on one or more calculated and recorded routes, according to exemplary embodiments.

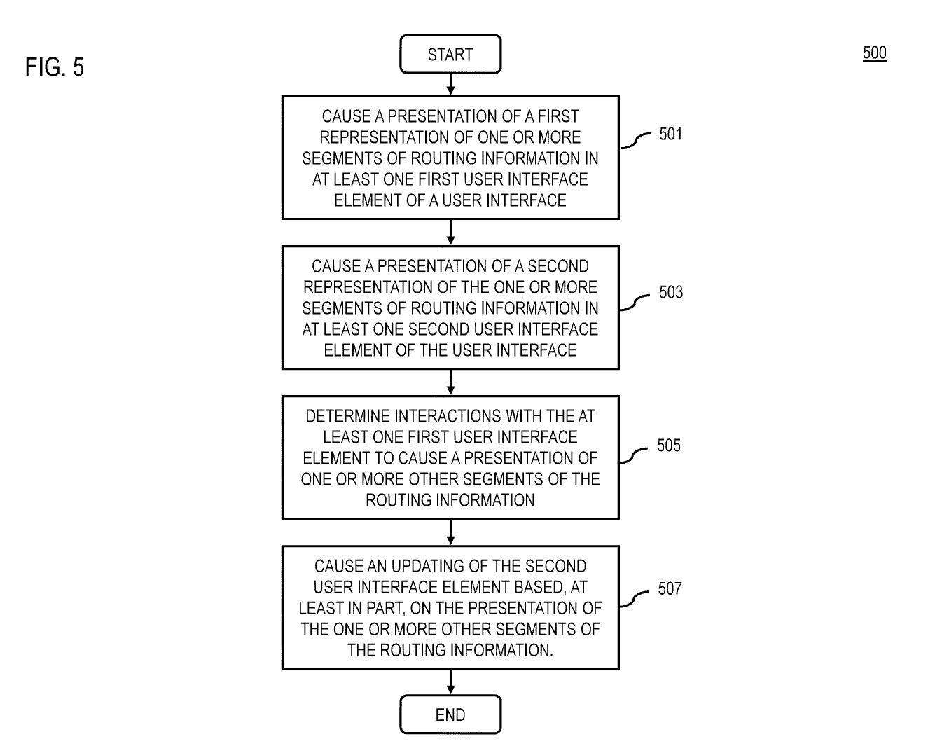

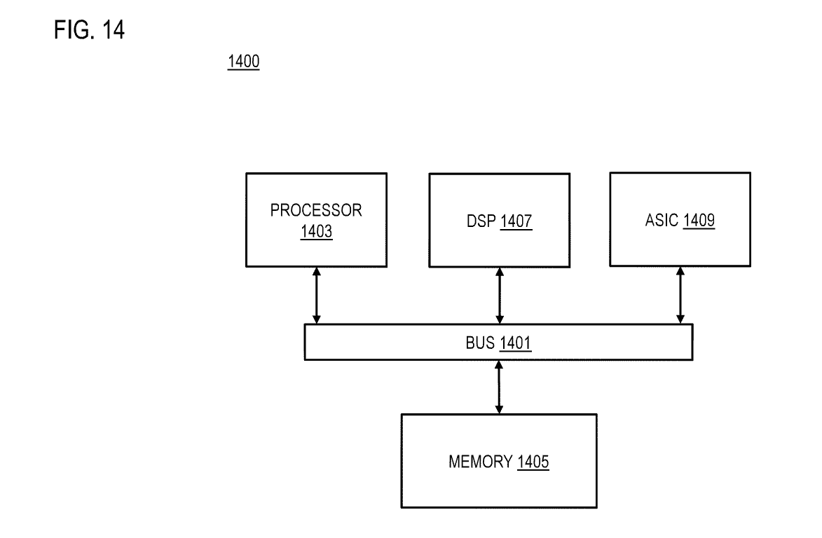

FIG. 5 is a flowchart of a process for causing a presentation of one or more segments of routing information in multiple user interface elements of a user interface for user selection, and causing an update of the multiple user interface elements based on the selection, according to one example embodiment. In one embodiment, the navigation platform 109 performs the process 500 and is implemented in, for instance, a chip set including a processor and a memory as shown in FIG. 14.

In step 501, the navigation platform 109 causes, at least in part, a presentation of a first representation of one or more segments of routing information in at least one first user interface element of a user interface. In one embodiment, a user may select at least one destination in a location based service for navigation purposes, whereby the navigation platform 109 causes, at least in part, an initiation of a presentation of user interface elements which may include, a display screen depicting a user selectable options menu corresponding with service functions offered by the location-based service. The at least one user may provide a touch-based interaction and/or a gesture-based interaction, whereby the navigation platform 109 may determine such input for specifying one or more map features for at least one user. Subsequently, the navigation platform 109 causes, at least in part, a presentation of at least one map features which may include a map view, an information view, or a combination thereof.

In step 503, the navigation platform 109 causes, at least in part, a presentation of a second representation of the one or more segments of routing information in at least one second user interface element of the user interface. In one embodiment, the at least one first user interface element, the at least one second user interface, or a combination thereof is one or more sub-windows of the whole user interface. In another embodiment, the first representation, the second representation, or a combination thereof include, at least in part, a map representation, a text-based representation, a multi-media representation, or combination thereof.

In step 505, the navigation platform 109 determines one or more interactions with the at least one first user interface element to cause, at least in part, a presentation of one or more other segments of the routing information. In one embodiment, the navigation platform 109 determining one or more interactions with the at least one first user interface element may further comprise of determining one or more swiping user actions on the at least one first user interface element. In one scenario, the navigation platform 109 may process and/or facilitate a processing of the input to determine one or more interactions with the user interface elements of a location-based service. Subsequently, the navigation platform 109 causes, at least in part, a rendering of one or more segments of the routing information of the at least one map feature in the user interface elements based, at least in part, on the one or more interactions. In one embodiment, the navigation platform 109 processes and/or facilitates a processing of contextual information, location information, or a combination thereof. In another embodiment, the navigation platform 109 causes, at least in part, a presentation of one or more advertisements based, at least in part, on contextual information, location information, or a combination thereof. In one scenario, the navigation platform 109 may determine that the at least one user of the UE 101 likes coffee, whereby the navigation platform 109 may advertise coffee shops nearby the one or more segments of the routing information. In one embodiment, the navigation platform 109 may determine offers for one or more products and/or services and may cause a presentation of such offers. In one scenario, the navigation platform 109 may determine discount offers at a coffee shop nearby the train station that the user of the UE 101 is going to board. The navigation platform 109 may cause an advertisement of the coffee shop alongside the presentation of the one or more segment of the routing information. In another example embodiment, the navigation platform 109 may scan billboards around areas close to one or more routes, and may cause a presentation of at least one advertisement accordingly.

In step 507, the navigation platform 109 causes, at least in part, an updating of the at least one second user interface element based, at least in part, on the presentation of the one or more other segments of the routing information. In one scenario, the sensors 105 may detect the touch based input and/or a gesture based input from the at least one user. The sensors 105 may relay the information to the navigation platform 109, whereby the navigation platform 109 may update the content of the user interface element for procuring accurate navigational information to the at least one user. In one example embodiment, the virtual point between the at least one first user interface element and the at least one second user interface element may act as a pivot. In one scenario, at least one user interaction with the at least one second user interface element may cause an update in the representation of one or more segments of routing information in at least one first user interface element of a user interface.

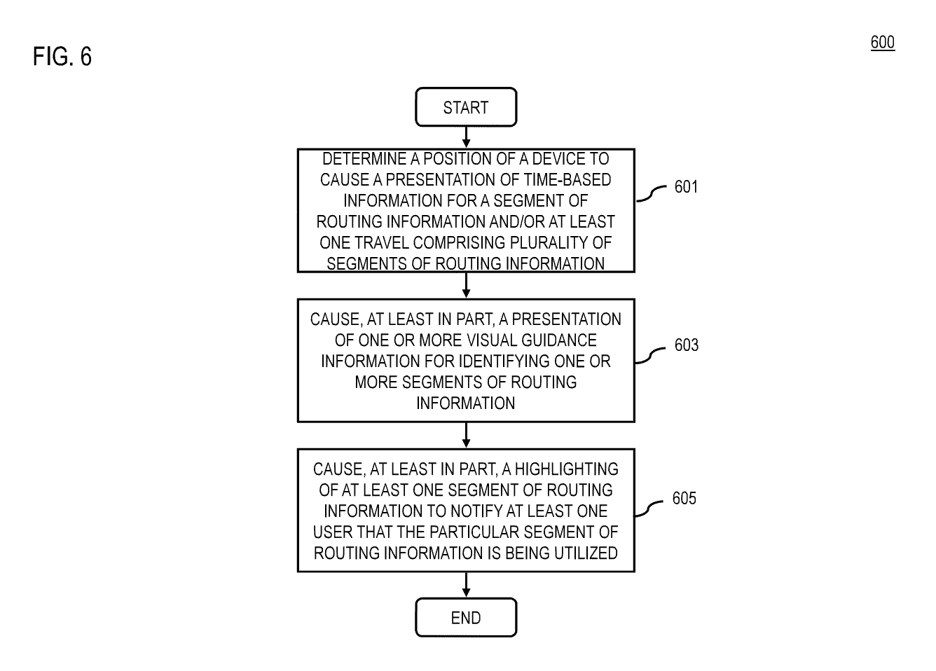

FIG. 6 is a flowchart of a process for determining a position of at least one device to cause, at least in part, a presentation of time-based information and/or color based information as a visual guidance for identifying one or more segments of routing information, according to one example embodiment. In one embodiment, the navigation platform 109 performs the process 600 and is implemented in, for instance, a chip set including a processor and a memory as shown in FIG. 14.

In step 601, the navigation platform 109 determines a position of at least one device to cause, at least in part, a presentation of time-based information for at least one segment of routing information, at least one travel comprising plurality of segments of routing information, or a combination thereof. In one scenario, the navigation platform 109 may determine the position of at least one UE 101 via sensors 105, and may provide routing information based on the position of the at least one UE 101. In another scenario, the navigation platform 109 may provide time-based information to the at least one user for the routing information determined on the basis of the position of the at least one UE 101. In one scenario, the navigation platform 109 may determine the position for the at least one UE 101 based on the user input.

In step 603, the navigation platform 109 causes, at least in part, a presentation of one or more colors and/or graphical indicators as a visual guidance information for identifying one or more segments of routing information. Needless to mention, navigation instructions can be highly text and sketch dependent, making it potentially difficult for users to correlate with the information depicted on a map. Therefore, the navigation platform 109 provides an approach for effective and efficient identification of the navigation instructions by providing a color representation for one or more segments of the routing information. The navigation platform 109 may display different colors for different segments of the routing information making it easier for the users to identify the one or more segments of routing information.

In step 605, the navigation platform 109 causes, at least in part, a highlighting of at least one segment of routing information to notify at least one user that the particular segment of routing information is being utilized. In one scenario, the navigation platform 109 may determine the position of the user/user device in the segment of the routing information. Subsequently, the navigation platform 109 may highlight a particular routing segment that is being utilized by the user. The highlighting of the at least one segment may notify the user about his/her position in the route information.

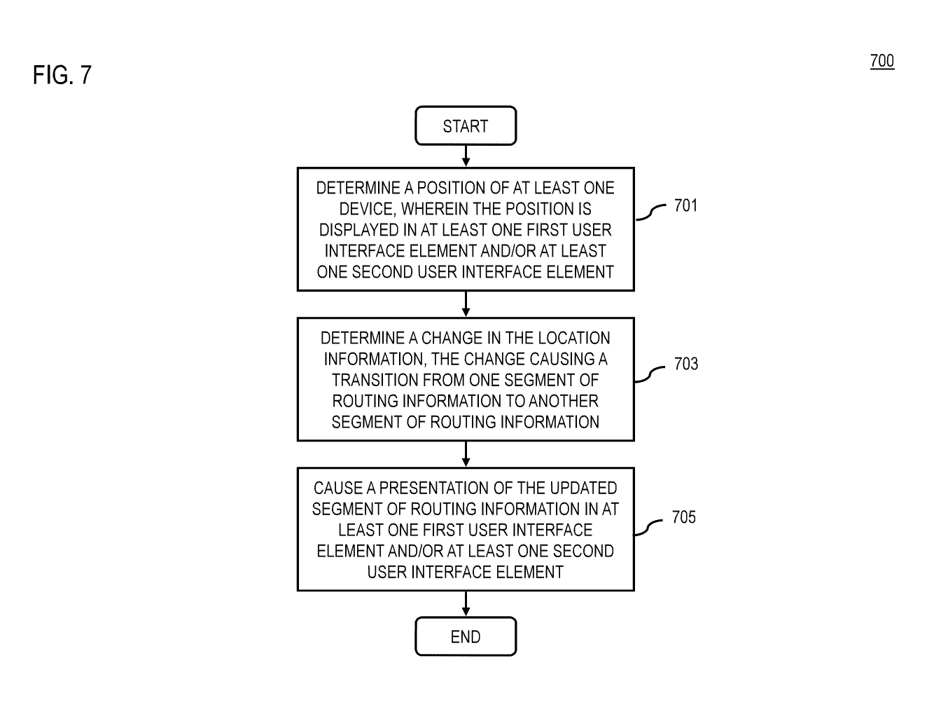

FIG. 7 is a flowchart of a process for determining changes in the location information for at least one user and causing a presentation of an updated segment of routing information in at least one first user interface element and/or at least one second user interface element, according to one example embodiment. In one embodiment, the navigation platform 109 performs the process 700 and is implemented in, for instance, a chip set including a processor and a memory as shown in FIG. 14.

In step 701, the navigation platform 109 determines a position of a user device, wherein the position is displayed in at least one first user interface element, at least one second user interface element, or a combination thereof. In one embodiment, the navigation platform 109 may use a tracking mechanism to obtain location data regarding the UE 101. In another embodiment, the navigation platform 109 may gather location information from GPS satellites to determine the location of the UE 101. Consequently, the navigation platform 109 may display the position of the at least one UE 101 in the user interface element of the UE 101 for user convenience.

In step 703, the navigation platform 109 determines a change in the location information, the change causing a transition from one segment of routing information to another segment of routing information. In one scenario, the navigation platform 109 gathers location information for at least one UE 101. Subsequently, the navigation platform 109 causes a movement of the user interface display representing the position of the at least one UE 101 within the one or more segments of the route information.

In step 705, the navigation platform 109 causes, at least in part, a presentation of the updated segment of routing information in at least one first user interface element, at least one second user interface element, or a combination thereof. In one scenario, the navigation platform 109 may cause a display of one or more segments of routing information based, at least in part, on the position of the at least one UE 101.

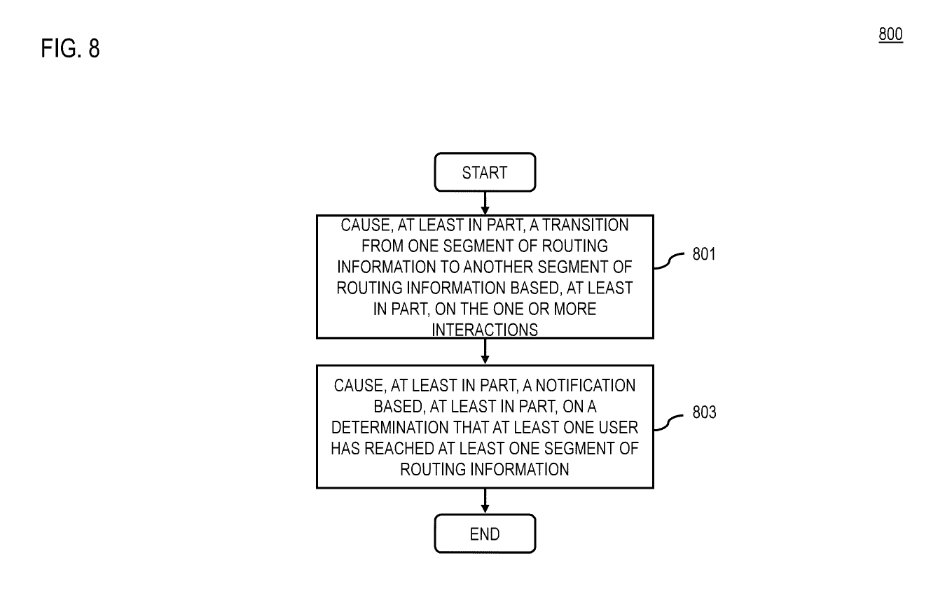

FIG. 8 is a flowchart of a process for causing a transition between routing segments and a notification based, at least in part, on the routing information, according to one example embodiment. In one embodiment, the navigation platform 109 performs the process 800 and is implemented in, for instance, a chip set including a processor and a memory as shown in FIG. 14.

In step 801, the navigation platform 109 causes, at least in part, a transition from one segment of routing information to another segment of routing information based, at least in part, on the one or more interactions, wherein one or more interactions with at least one first user interface element causes panning of the map representation in the at least one second user interface element. In one example embodiment, the one or more interactions include, at least in part, a touch-based interaction, a gesture-based interaction, or a combination thereof. In one scenario, the request may be a type of touch input, such as, a swipe on the map representation may cause a panning of the map. As another example, the touch input may be a selection of a specific location for viewing of a specific street related image. By way of touch based input, the user clicks on a specific location on the interface. In response, the navigation platform 109 renders a user interface element for presenting a map image for the at least one route. The map image features various indicators associated with the selected route including one or more walking directions, driving directions, transit directions, bicycling directions etc. In one embodiment, the panning and/or swiping of the second user interface element (the map view) for getting comprehensive information of a map does not change the presentation and/or content of the first user interface element (the information view).

In step 803, the navigation platform 109 causes, at least in part, a notification based, at least in part, on a determination that at least one user has reached at least one segment of routing information, wherein at least one notification include, textual alert, audio alert, vibration, or a combination thereof. In one example embodiment, the navigation platform 109 may notify at least one user of the UE 101 upon determination that the at least one segment of routing information is complete. In one scenario, at least one user boards a train to XYZ station, the navigation platform 109 may notify a user via a text message that the destination is approaching and the user needs to depart the train.

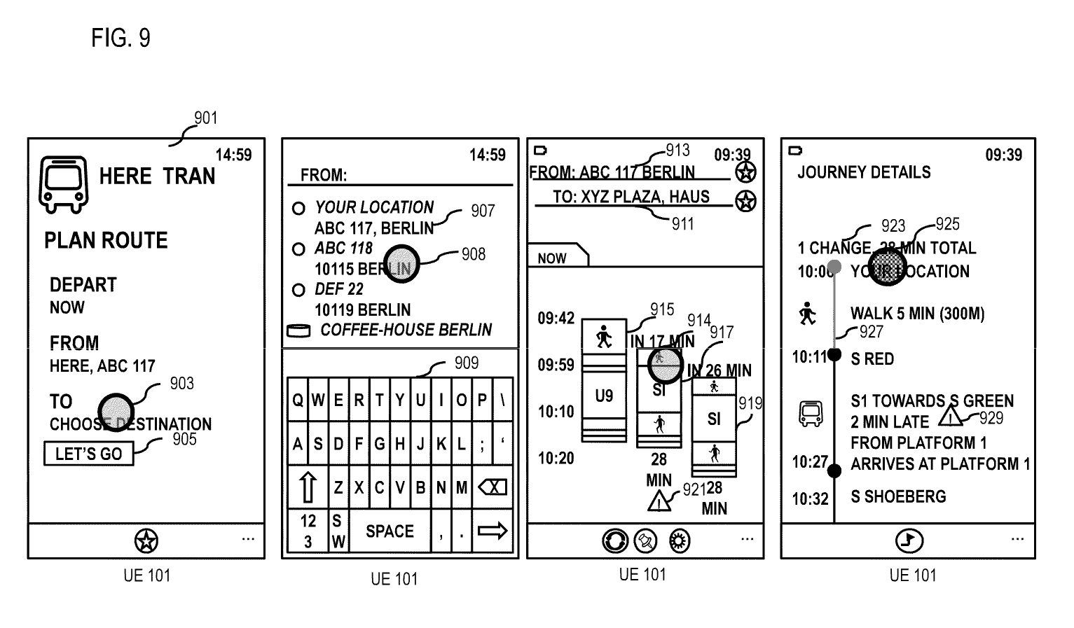

FIG. 9 is a diagram of a user interface utilized in the process of initiating a navigation application that allows multiple display of selected routes in a map view and/or an information view, according to one example embodiment. In one scenario, a user may want to travel to XYZ plaza and may want to use the navigation application in his/her UE 101. The user may activate the navigation application by a touch based interaction, whereby the user may be presented with the display screen 901. The user may be prompted to touch on the “let's go” tab (905) to choose a destination for navigation purposes (903). Then, the user is presented with the option of entering his/her current location. When the user is entering his/her current location, the navigation platform 109 may query the geographic database 111 and may provide the user with a list of destination for selection (907). However, if the list does not include the user's destination, the user may continue with typing the location information by using the display screen with selectable options menu functions (909). Subsequently, the navigation platform 109 may present the user with time-based information and mode of travel information to the at least one destination (911) from his/her current location (913). The user may be presented with the option of selecting the travel plan as per his/her convenience. If the user is in a hurry, he/she may opt for the first travel plan (915), wherein the user needs to walk for 17 minutes and then board the train to reach the at least one destination (915). If the user is not in a rush then the user may opt for the second (917) or third (919) travel plan. In one scenario, the user may be presented with a notification if there is a delay in the train he/she is supposed to board (921). Consequently, the navigation platform 109 causes a display of the journey details based, at least in part, on selection of the travel plan (915, 917, and 919) by the user. In one scenario, the navigation platform 109 may present the user with the total duration of the travel plan and the number of travel changes the user needs to make. The navigation platform 109 may present a summary line (923) representing one or more segments of routing information, wherein the segments of routing information may be shown in different colors for user convenience. In one scenario, the colored circle (903, 908, 914, 925) may indicate finger position and selecting and/or swiping action on the at least one display. In another scenario, the at least one segment of the summary line representing the journey details may be colored to notify the user that the he/she is still in that segment of the travel (927). In one scenario, the navigation platform 109 may notify the user if there has been a delay or cancellation in the mode of transport the user is to board to reach the at least one destination (929).

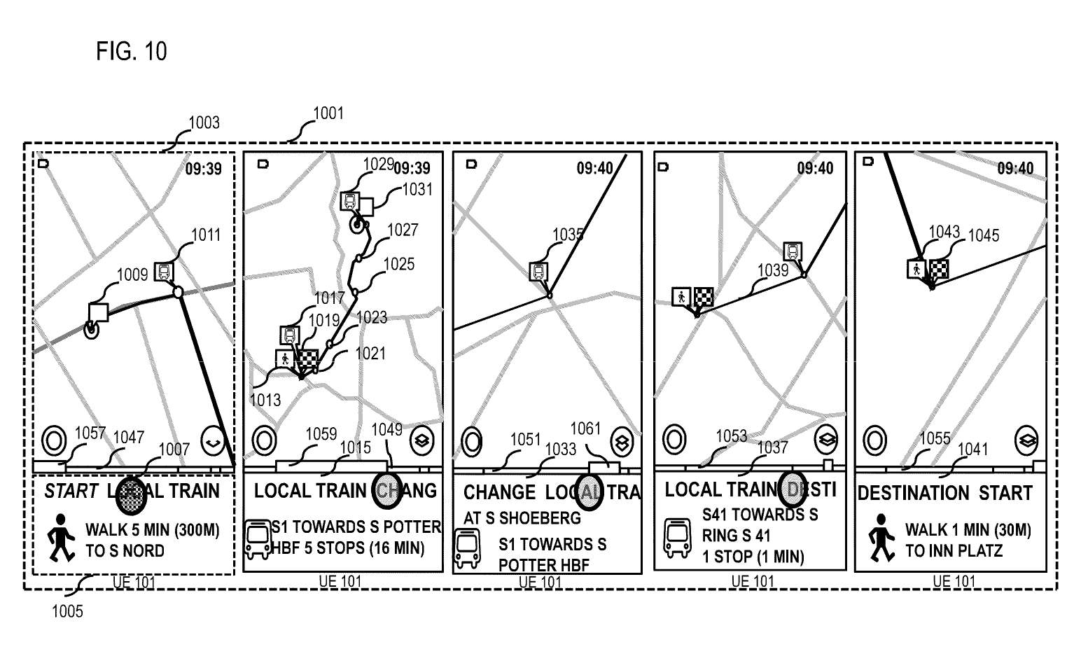

FIG. 10 is a diagram of a user interface utilized in the process of causing a presentation of navigation segments in multiple user interface elements, according to one example embodiment. In one scenario, the rectangular outline 1001 represents at least one travel comprising plurality of segments of routing information. While, the rectangular outline 1003 describes a map view of a specific segment of the selected route. At the same time, the rectangular outline 1005 describes an information view of the specific segment of the selected route. In one example embodiment, the application allows browsing/selecting of the specific segments of the selected journey on separate map and information view by swiping sideways and/or up-down, e.g. by one or more fingers, on either the information view or the map view, which further causes also updating information relating to the browsed/selected segment on the other view. The user may swipe left or right on the information view area to jump between different segments of routing information. Consequently, the map view is updated to describe the new segment of routing information on the information view, in such manner, the map view may act as a pivot for the information view. In one scenario, a user may be navigated to walk towards a train station and the user may be provided with the distance and time information (1007). In addition, the user may be further guided with a map view that provides the user's current location (1009) and the direction towards the train station (1011). Once the user completes the walking segment of the travel (1013), the navigation platform 109 may automatically update the routing information and/or the user may update the routing information with a touch-based input. Subsequently, the navigation platform 109 may cause a display of a train journey wherein the user may be provided with the duration of the at least one train travel and/or the number of stops (1015). In one scenario, the map information may provide the user with a graphical representation of the at least one train the user is boarding (1017), the checkered flag (1019) may represent one or more notifications to the user and the small dots (1021, 1023, 1025, 1027) on the travel line may represent the number of stops towards the next travel segment (1029). In addition, the user may be provided with an alert (1031) once the user reaches the train station where the user needs to board another train. In one scenario, a user may be presented with information to board another train to reach the at least one destination, for instance, the train number, the platform number, providing notification if there is a delay in the arrival of the train etc. (1033, 1035). In another scenario, the navigation platform 109 may cause a display for another train ride, whereby the user may be presented with the duration of the at least one train travel and/or the number of train stops (1037). Further, the user may be provided with information on the platform the train is arriving and navigation instructions towards the platform (1039). In one scenario, the at least one user is provided with a visual display for walking towards the final destination upon completion of the one or more segments of the routing information (1041, 1043, 1045). In one scenario, the area between the information view and the map view (1047, 1049, 1051, 1053, 1055) may represent the segments of a travel to the at least one destination, and the at least one bolded box (1057, 1059, 1061) may represent the at least one current segment of the journey that is being viewed by the user.

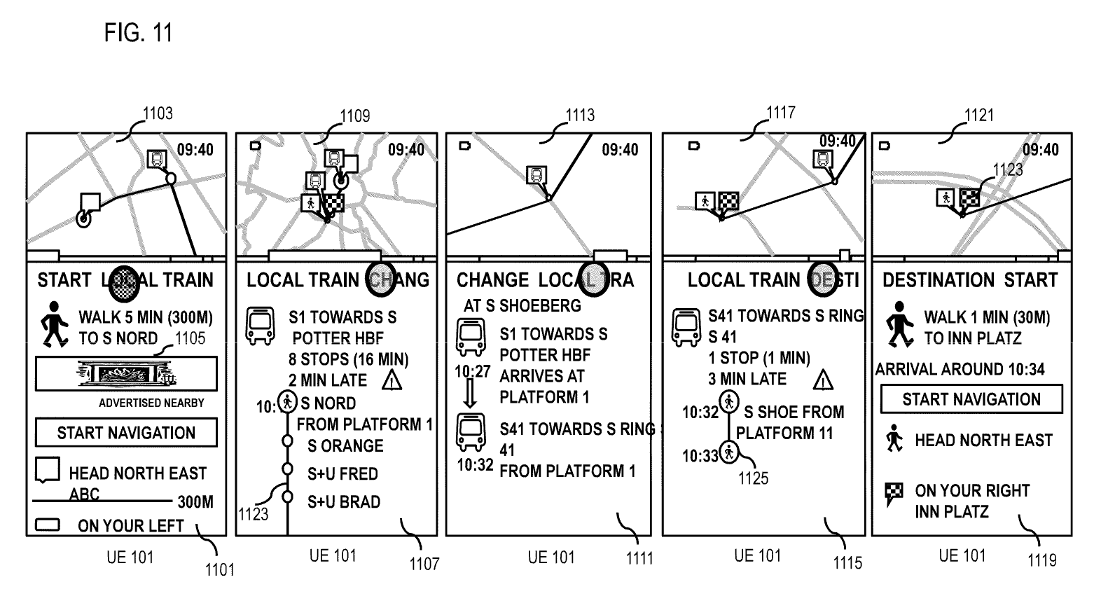

FIG. 11 is a diagram of a user interface utilized in describing the one or more segment of the routing information with expanded information view (1101, 1107, 1111, 1115,1119) and a minimized map view (1103, 1109,1113,1117,1121), according to one example embodiment. In one example embodiment, the user may change the size of the information view by swiping in an upward or a downward direction. In another example embodiment, the map view and the information view can be expanded and collapsed either by clicking on the segment headers, or by clicking in the top part of the list segment in the desired direction. Further, the map view may be zoomed to display key parts. In one scenario, a zooming of the map view may cause the size of the alert or notification box to change accordingly but the font sizes remains the same, so that different levels of information can be shown in different zoom levels. In one example embodiment, the expanded information view may comprise of at least one advertisement that may interest the user when the user is traveling towards his/her destination (1105). In another example embodiment, an expanded summary line representing the segments of the routing information with color indicators may be displayed for user convenience (1123, 1125). In one scenario, at least one user may be provided with an alert and/or a notification on the information view (1107, 1115). In another scenario, the information view is an indication of the itinerary for the at least one destination, and can be swiped through. In some embodiment, the information view is not shown, for example, the information view may be divided between the alerts and/or notification and/or the information view.

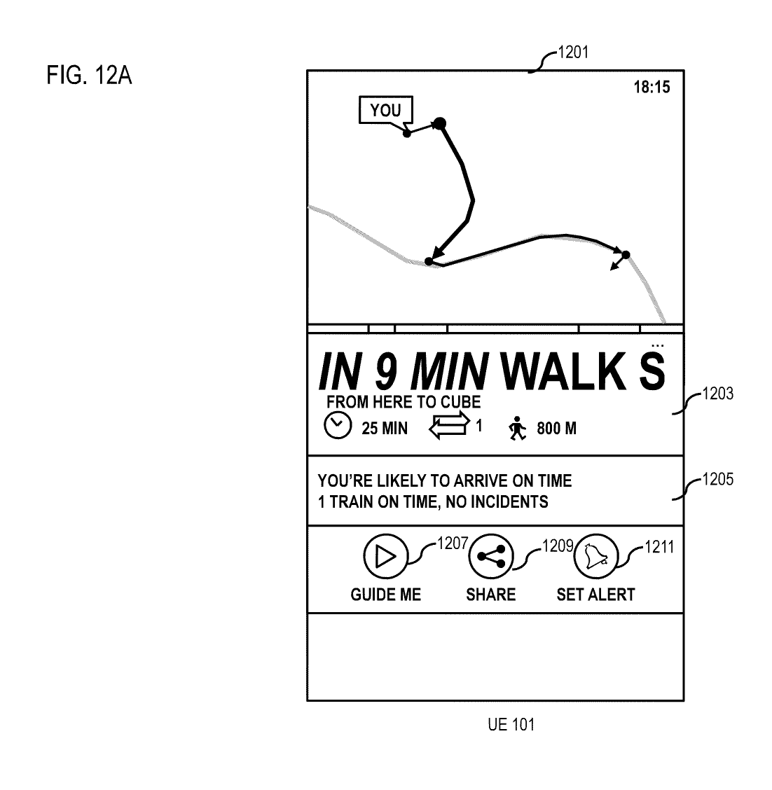

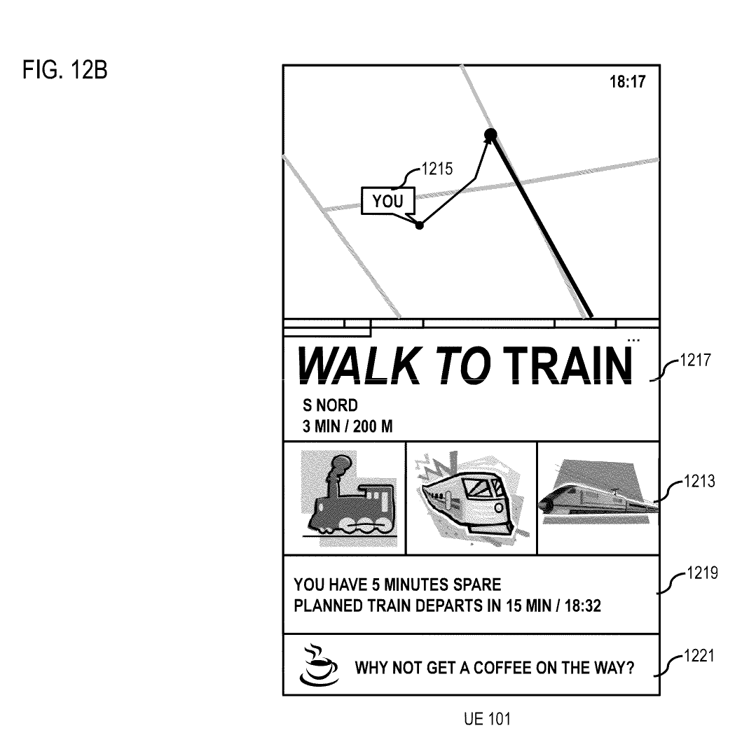

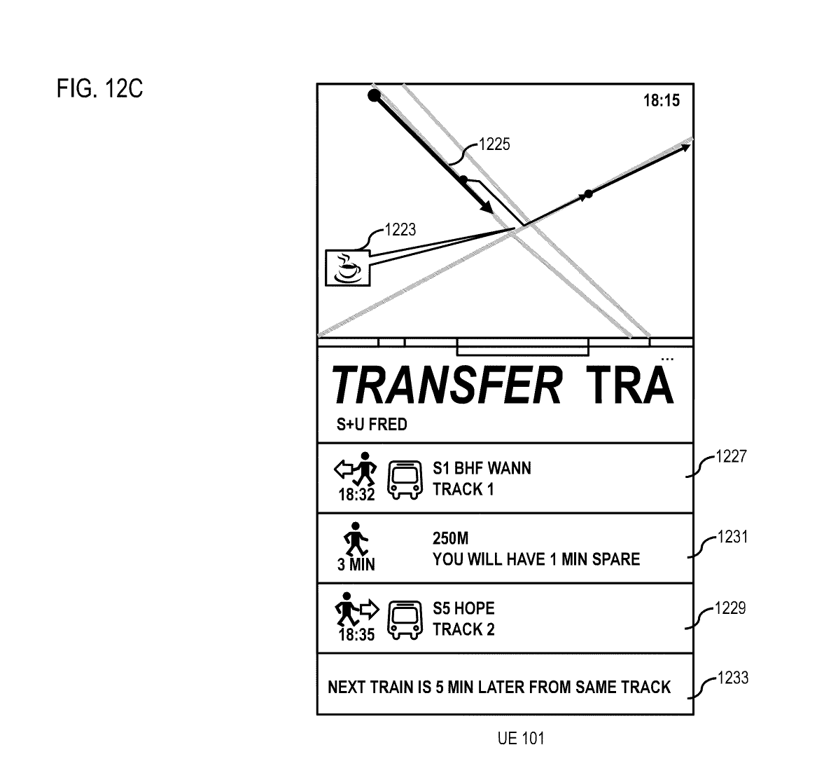

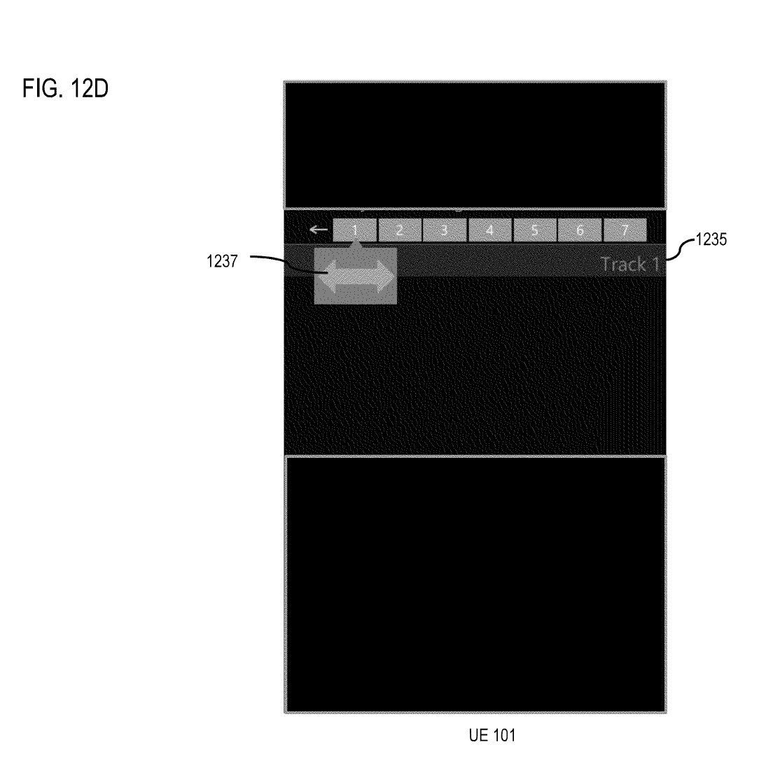

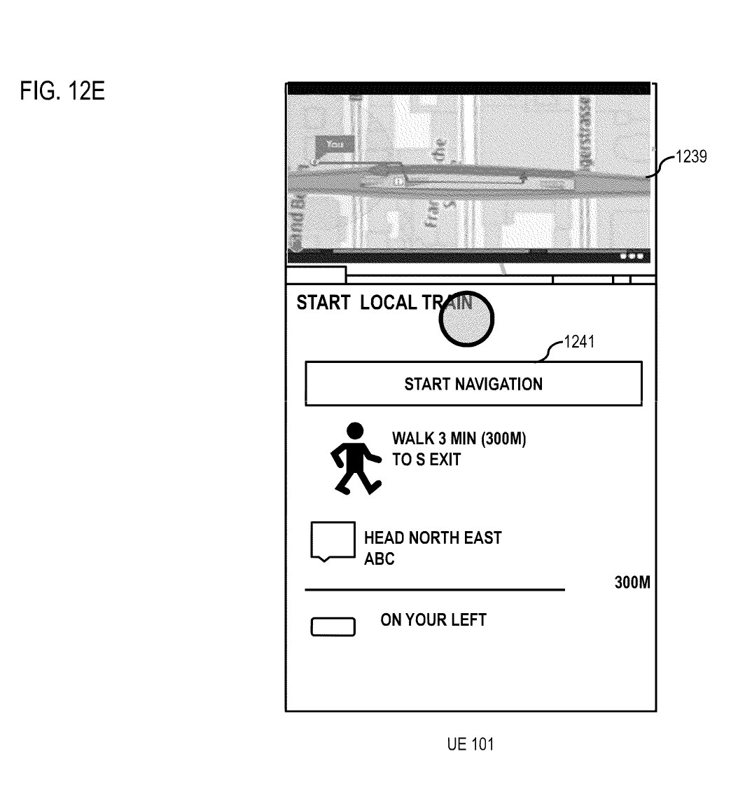

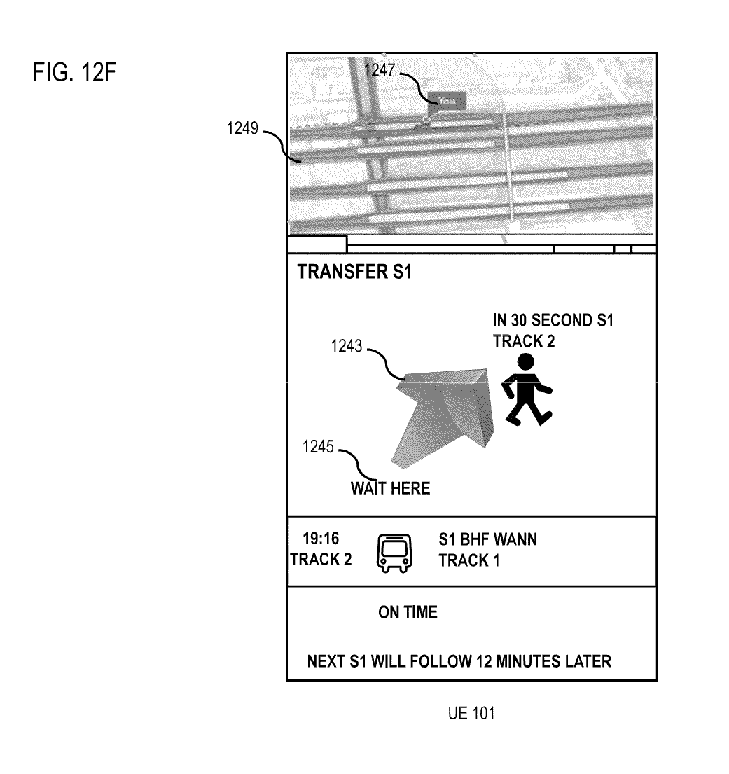

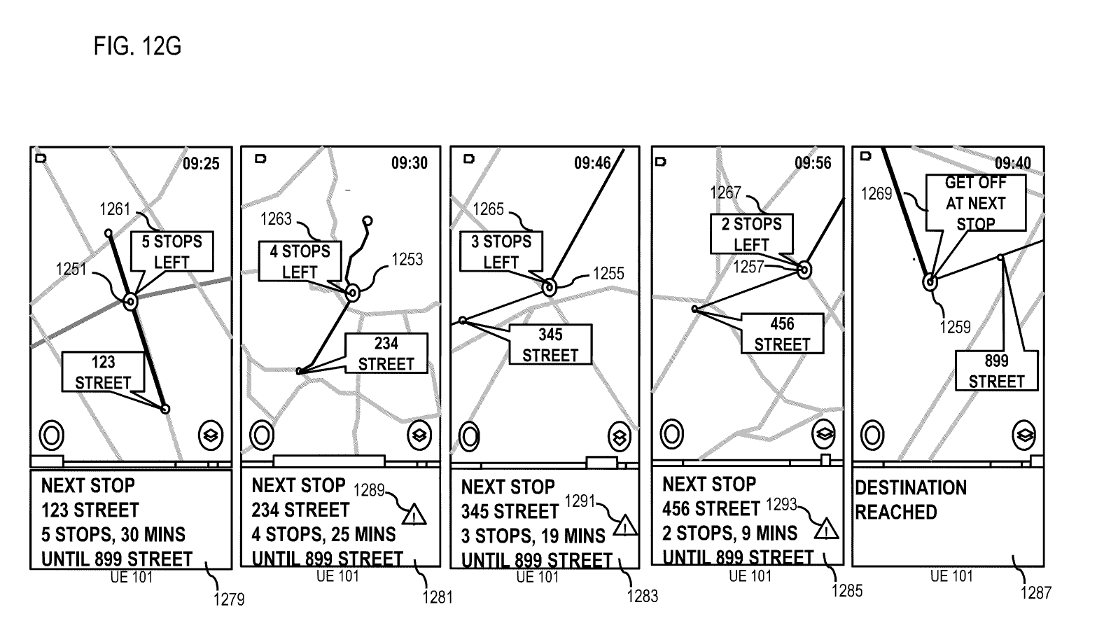

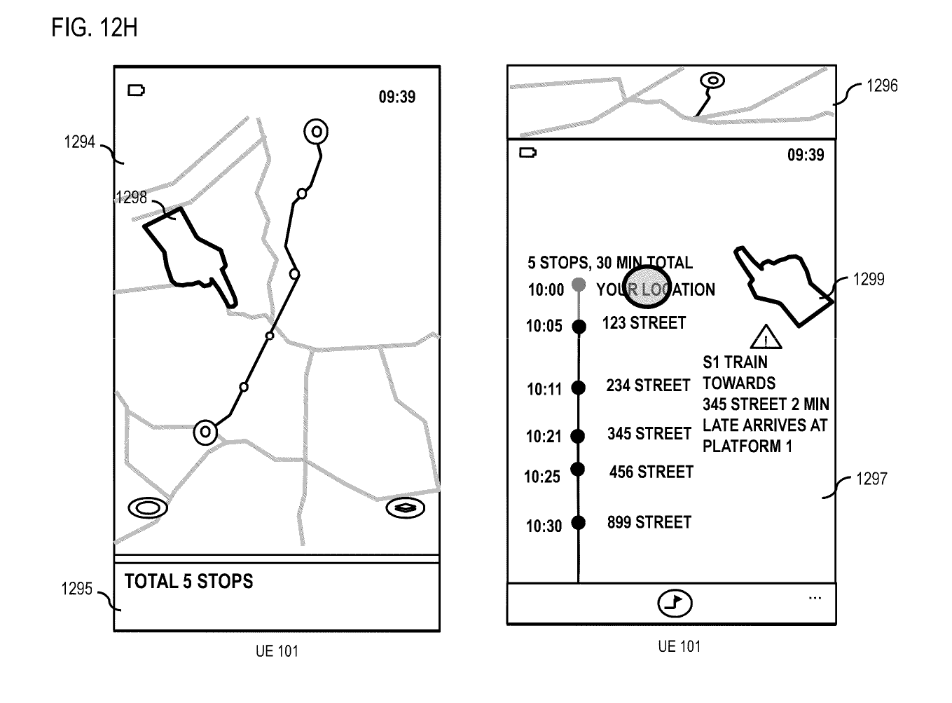

FIGS. 12A-12H are diagrams of user interfaces utilized in the processes of FIG. 3, according to various example embodiments. In FIG. 12A a user is presented with multiple display of one or more map features which includes a map view (1201) and/or an information view (1203). In one example embodiment, the information view may comprise estimated walking time, distance information, journey related alerts, etc. (1203). Further, the information view may also comprise a notification to the user that the train is on time and if the user arrives at the train station on time then he/she can board the train in a timely manner (1205). In another example embodiment, the user may activate navigation instructions or cause a rerouting of the travel destination by tapping on the guide me tab (1207), the user may share the travel details with his/her peers by clicking the share tab (1209), and the user may set one or more alert during the at least one navigation segment by clicking on set alert tab (1211). In one scenario, the at least one user may be further provided with an alert and/or a notification with the final destination pointer (1211).

In FIG. 12B the navigation platform 109 may present a user is also presented with one or more pictures (1213) alongside the map representation (1215) and the text based representation (1217) of the location information. In one scenario, the user may be presented with a picture of the train he/she has to board. In addition, the navigation platform 109 may notify the user of any spare time during his/her travel (1219), and may recommend at least one activity (1221), for instance, the user may have 5 minutes of spare time and the navigation platform 109 may recommend the user to get a coffee during the spare time.

In FIG. 12C the navigation platform 109 may present the user with the location information of the at least one coffee shop (1223) in the map view alongside the routing information for the at least one destination (1225). In one scenario, the user may be presented with a block diagram of the summary of the travel. Firstly, the user needs to board an S1 train (1227). Secondly, the user needs to exit at another train station to board S5 train (1229). Subsequently, the navigation platform 109 may inform the user of any spare time the user may have while waiting for S5 train (1231), and may further update on the schedules of the other trains (1233).

FIG. 12D is a user interface representation of a presentation to the at least one user with information on the most suitable carriage in the at least one train during a current routing context (1235). In one scenario, the navigation platform 109 may provide the at least one user with guidance to a specific location in a train and a related place to enter the train (1237). The navigation platform 109 optimizes the travel time by taking into consideration the crowdedness on a station and/or within a train. Such feature also helps one or more users with moving their baby carriage, a wheelchair, a bike and other items, if any, to a dedicated wagon or location in the train/tram/metro.

FIG. 12E is a user interface that represents a scenario whereby the at least one user is presented with a station map (1239). The navigation platform 109 may then provide the at least one user with indoor navigation as a part of the general route navigation (1241). Such indoor navigation to a specific location to enter the train enhances the travel experience for the at least one user. In one scenario, a user may touch the “start navigation” tab whereby the user is navigated to the most suitable section of the train. In one scenario, the at least one suitable section of the train may be determined on the basis of density, easy access to the exit, easy access to the other transfer trains, seat availability, etc.

FIG. 12F is a user interface that represents a scenario whereby a user is provided with a guidance arrow (1243) at the point of transfer. In one scenario, a 2D or 3D representation of an arrow to guide a user to the right direction may enhance user convenience. Further, the arrow may pinpoint the exact location the user should wait for the train (1245). In one scenario, the at least one user may be further provided with a presentation of the his current location (1247) and the distance he/she needs to walk to reach the recommended division of the train station to board the most suitable carriage of the train (1249).

FIG. 12G is a user interface that represents a scenario whereby a user is provided with a real time guidance and alerts during their travel to the at least one destination. In one scenario, the at least one notification and/or alerts may be attached to the indicator of a current location pointer (1251, 1253, 1255, 1257) on the route in the map view, the alert may be dynamic and is attached to the user's position indicating real-time information. In one scenario, the at least one user may be alerted and/or notified regarding the number of stops to the at least one destination (1261, 1263, 1265, 1267). In another scenario, the at least one user may be provided with information on the time to the next station, time to next transfer, name of the transfer station, name of the next station, or a combination thereof (1279, 1281, 1283, 1285, 1287). In addition, the at least one user may be provided with a “get off at next stop” alert or notification (1269) to ensure that the user does not miss the transfer station or the destination. In another scenario, the at least one user may be guided to a website that may provide detail information on the routing information to the at least one destination, wherein the user may query the reason for the delay or cancellation of the at least one mode of transportation. In some embodiment, by using the users' current location pointer (1251, 1253, 1255, 1257) and the alerts and/or notification box (1289, 1291, 1293) the user can report train delays, cancellation, problems on the station etc. if not yet informed by the system. Such report may automatically include current location information, temporal information, public transport information etc.

FIG. 12H is a user interface that represents a zoomed level display of the information view and/or the map view based, at least in part, on user interaction. In one embodiment, the panning and/or swiping (1298) of the second user interface element (the map view) for getting comprehensive information of a map may cause an expansion (1294) of the second user interface element and contraction (1295) of the first user interface element (the information view). On the other hand, the at least one user may drag the information view (1299) to see his/her itinerary and/or where he/she is situated. Consequently, the enlargement (1297) of the presentation and/or content of the first user interface element (the information view) causes diminution (1296) in the display of the second user interface element (the map view).

The processes described herein for causing a presentation of one or more segments of routing information in multiple user interface elements of a user interface for user selection, and causing an update of the multiple user interface elements based on the selection may be advantageously implemented via software, hardware, firmware or a combination of software and/or firmware and/or hardware. For example, the processes described herein, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

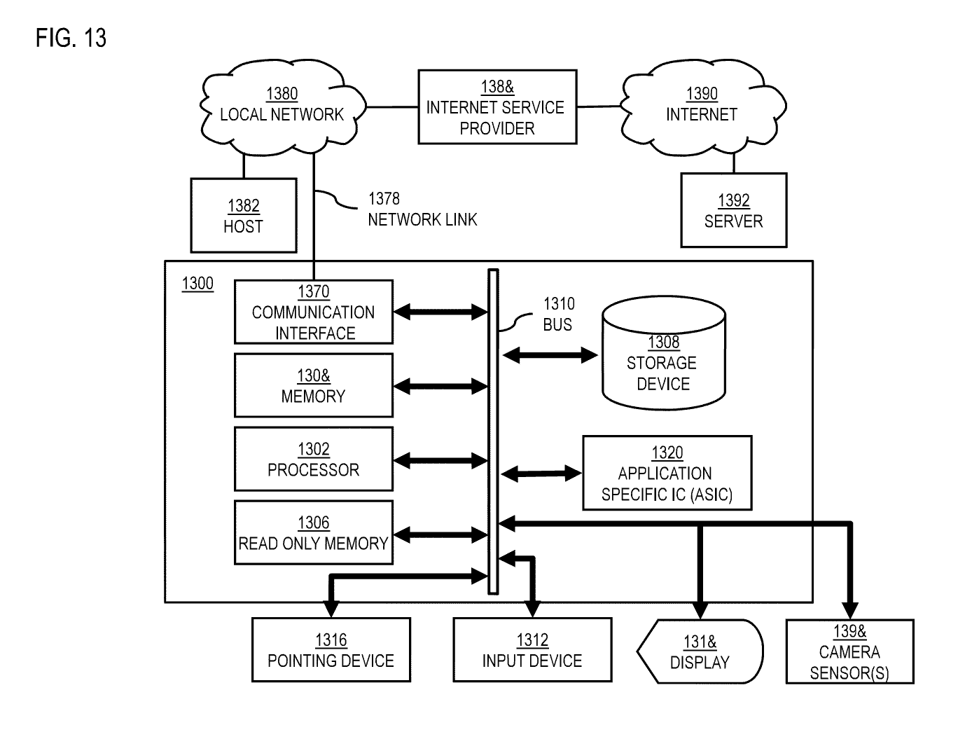

FIG. 13 illustrates a computer system 1300 upon which an embodiment of the invention may be implemented. Although computer system 1300 is depicted with respect to a particular device or equipment, it is contemplated that other devices or equipment (e.g., network elements, servers, etc.) within FIG. 13 can deploy the illustrated hardware and components of system 1300. Computer system 1300 is programmed (e.g., via computer program code or instructions) to cause a presentation of one or more segments of routing information in multiple user interface elements of a user interface for user selection, and causing an update of the multiple user interface elements based on the selection as described herein and includes a communication mechanism such as a bus 1310 for passing information between other internal and external components of the computer system 1300. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 1300, or a portion thereof, constitutes a means for performing one or more steps of causing a presentation of one or more segments of routing information in multiple user interface elements of a user interface for user selection, and causing an update of the multiple user interface elements based on the selection.

A bus 1310 includes one or more parallel conductors of information so that information is transferred quickly among devices coupled to the bus 1310. One or more processors 1302 for processing information are coupled with the bus 1310.

A processor (or multiple processors) 1302 performs a set of operations on information as specified by computer program code related to cause a presentation of one or more segments of routing information in multiple user interface elements of a user interface for user selection, and causing an update of the multiple user interface elements based on the selection. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 1310 and placing information on the bus 1310. The set of operations also typically include comparing two or more units of information, shifting positions of units of information, and combining two or more units of information, such as by addition or multiplication or logical operations like OR, exclusive OR (XOR), and. Each operation of the set of operations that can be performed by the processor is represented to the processor by information called instructions, such as an operation code of one or more digits. A sequence of operations to be executed by the processor 1302, such as a sequence of operation codes, constitute processor instructions, also called computer system instructions or, simply, computer instructions. Processors may be implemented as mechanical, electrical, magnetic, optical, chemical, or quantum components, among others, alone or in combination.

Computer system 1300 also includes a memory 1304 coupled to bus 1310. The memory 1304, such as a random access memory (RAM) or any other dynamic storage device, stores information including processor instructions for causing a presentation of one or more segments of routing information in multiple user interface elements of a user interface for user selection, and causing an update of the multiple user interface elements based on the selection. Dynamic memory allows information stored therein to be changed by the computer system 1300. RAM allows a unit of information stored at a location called a memory address to be stored and retrieved independently of information at neighboring addresses. The memory 1304 is also used by the processor 1302 to store temporary values during execution of processor instructions. The computer system 1300 also includes a read only memory (ROM) 1306 or any other static storage device coupled to the bus 1310 for storing static information, including instructions, that is not changed by the computer system 1300. Some memory is composed of volatile storage that loses the information stored thereon when power is lost. Also coupled to bus 1310 is a non-volatile (persistent) storage device 1308, such as a magnetic disk, optical disk or flash card, for storing information, including instructions, that persists even when the computer system 1300 is turned off or otherwise loses power.

Information, including instructions for causing a presentation of one or more segments of routing information in multiple user interface elements of a user interface for user selection, and causing an update of the multiple user interface elements based on the selection, is provided to the bus 1310 for use by the processor from an external input device 1312, such as a keyboard containing alphanumeric keys operated by a human user, a microphone, an Infrared (IR) remote control, a joystick, a game pad, a stylus pen, a touch screen, or a sensor. A sensor detects conditions in its vicinity and transforms those detections into physical expression compatible with the measurable phenomenon used to represent information in computer system 1300. Other external devices coupled to bus 1310, used primarily for interacting with humans, include a display device 1314, such as a cathode ray tube (CRT), a liquid crystal display (LCD), a light emitting diode (LED) display, an organic LED (OLED) display, a plasma screen, or a printer for presenting text or images, and a pointing device 1316, such as a mouse, a trackball, cursor direction keys, or a motion sensor, for controlling a position of a small cursor image presented on the display 1314 and issuing commands associated with graphical elements presented on the display 1314, and one or more camera sensors 1394 for capturing, recording and causing to store one or more still and/or moving images (e.g., videos, movies, etc.) which also may comprise audio recordings. In some embodiments, for example, in embodiments in which the computer system 1300 performs all functions automatically without human input, one or more of external input device 1312, display device 1314 and pointing device 1316 may be omitted.

In the illustrated embodiment, special purpose hardware, such as an application specific integrated circuit (ASIC) 1320, is coupled to bus 1310. The special purpose hardware is configured to perform operations not performed by processor 1302 quickly enough for special purposes. Examples of ASICs include graphics accelerator cards for generating images for display 1314, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 1300 also includes one or more instances of a communications interface 1370 coupled to bus 1310. Communication interface 1370 provides a one-way or two-way communication coupling to a variety of external devices that operate with their own processors, such as printers, scanners and external disks. In general the coupling is with a network link 1378 that is connected to a local network 1380 to which a variety of external devices with their own processors are connected. For example, communication interface 1370 may be a parallel port or a serial port or a universal serial bus (USB) port on a personal computer. In some embodiments, communications interface 1370 is an integrated services digital network (ISDN) card or a digital subscriber line (DSL) card or a telephone modem that provides an information communication connection to a corresponding type of telephone line. In some embodiments, a communication interface 1370 is a cable modem that converts signals on bus 1310 into signals for a communication connection over a coaxial cable or into optical signals for a communication connection over a fiber optic cable. As another example, communications interface 1370 may be a local area network (LAN) card to provide a data communication connection to a compatible LAN, such as Ethernet. Wireless links may also be implemented. For wireless links, the communications interface 1370 sends or receives or both sends and receives electrical, acoustic or electromagnetic signals, including infrared and optical signals, that carry information streams, such as digital data. For example, in wireless handheld devices, such as mobile telephones like cell phones, the communications interface 1370 includes a radio band electromagnetic transmitter and receiver called a radio transceiver. In certain embodiments, the communications interface 1370 enables connection to the communication network 107 for causing a presentation of one or more segments of routing information in multiple user interface elements of a user interface for user selection, and causing an update of the multiple user interface elements based on the selection to the UE 101.

The term “computer-readable medium” as used herein refers to any medium that participates in providing information to processor 1302, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 1308. Volatile media include, for example, dynamic memory 1304. Transmission media include, for example, twisted pair cables, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 1320.

Network link 1378 typically provides information communication using transmission media through one or more networks to other devices that use or process the information. For example, network link 1378 may provide a connection through local network 1380 to a host computer 1382 or to equipment 1384 operated by an Internet Service Provider (ISP). ISP equipment 1384 in turn provides data communication services through the public, world-wide packet-switching communication network of networks now commonly referred to as the Internet 1390.

A computer called a server host 1392 connected to the Internet hosts a process that provides a service in response to information received over the Internet. For example, server host 1392 hosts a process that provides information representing video data for presentation at display 1314. It is contemplated that the components of system 1300 can be deployed in various configurations within other computer systems, e.g., host 1382 and server 1392.

At least some embodiments of the invention are related to the use of computer system 1300 for implementing some or all of the techniques described herein. According to one embodiment of the invention, those techniques are performed by computer system 1300 in response to processor 1302 executing one or more sequences of one or more processor instructions contained in memory 1304. Such instructions, also called computer instructions, software and program code, may be read into memory 1304 from another computer-readable medium such as storage device 1308 or network link 1378. Execution of the sequences of instructions contained in memory 1304 causes processor 1302 to perform one or more of the method steps described herein. In alternative embodiments, hardware, such as ASIC 1320, may be used in place of or in combination with software to implement the invention. Thus, embodiments of the invention are not limited to any specific combination of hardware and software, unless otherwise explicitly stated herein.

The signals transmitted over network link 1378 and other networks through communications interface 1370, carry information to and from computer system 1300. Computer system 1300 can send and receive information, including program code, through the networks 1380, 1390 among others, through network link 1378 and communications interface 1370. In an example using the Internet 1390, a server host 1392 transmits program code for a particular application, requested by a message sent from computer 1300, through Internet 1390, ISP equipment 1384, local network 1380 and communications interface 1370. The received code may be executed by processor 1302 as it is received, or may be stored in memory 1304 or in storage device 1308 or any other non-volatile storage for later execution, or both. In this manner, computer system 1300 may obtain application program code in the form of signals on a carrier wave.

Various forms of computer readable media may be involved in carrying one or more sequence of instructions or data or both to processor 1302 for execution. For example, instructions and data may initially be carried on a magnetic disk of a remote computer such as host 1382. The remote computer loads the instructions and data into its dynamic memory and sends the instructions and data over a telephone line using a modem. A modem local to the computer system 1300 receives the instructions and data on a telephone line and uses an infra-red transmitter to convert the instructions and data to a signal on an infra-red carrier wave serving as the network link 1378. An infrared detector serving as communications interface 1370 receives the instructions and data carried in the infrared signal and places information representing the instructions and data onto bus 1310. Bus 1310 carries the information to memory 1304 from which processor 1302 retrieves and executes the instructions using some of the data sent with the instructions. The instructions and data received in memory 1304 may optionally be stored on storage device 1308, either before or after execution by the processor 1302.

FIG. 14 illustrates a chip set or chip 1400 upon which an embodiment of the invention may be implemented. Chip set 1400 is programmed to cause a presentation of one or more segments of routing information in multiple user interface elements of a user interface for user selection, and causing an update of the multiple user interface elements based on the selection as described herein and includes, for instance, the processor and memory components described with respect to FIG. 13 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 1400 can be implemented in a single chip. It is further contemplated that in certain embodiments the chip set or chip 1400 can be implemented as a single “system on a chip.” It is further contemplated that in certain embodiments a separate ASIC would not be used, for example, and that all relevant functions as disclosed herein would be performed by a processor or processors. Chip set or chip 1400, or a portion thereof, constitutes a means for performing one or more steps of providing user interface navigation information associated with the availability of functions. Chip set or chip 1400, or a portion thereof, constitutes a means for performing one or more steps of causing a presentation of one or more segments of routing information in multiple user interface elements of a user interface for user selection, and causing an update of the multiple user interface elements based on the selection.

In one embodiment, the chip set or chip 1400 includes a communication mechanism such as a bus 1401 for passing information among the components of the chip set 1400. A processor 1403 has connectivity to the bus 1401 to execute instructions and process information stored in, for example, a memory 1405. The processor 1403 may include one or more processing cores with each core configured to perform independently. A multi-core processor enables multiprocessing within a single physical package. Examples of a multi-core processor include two, four, eight, or greater numbers of processing cores. Alternatively or in addition, the processor 1403 may include one or more microprocessors configured in tandem via the bus 1401 to enable independent execution of instructions, pipelining, and multithreading. The processor 1403 may also be accompanied with one or more specialized components to perform certain processing functions and tasks such as one or more digital signal processors (DSP) 1407, or one or more application-specific integrated circuits (ASIC) 1409. A DSP 1407 typically is configured to process real-world signals (e.g., sound) in real time independently of the processor 1403. Similarly, an ASIC 1409 can be configured to performed specialized functions not easily performed by a more general purpose processor. Other specialized components to aid in performing the inventive functions described herein may include one or more field programmable gate arrays (FPGA), one or more controllers, or one or more other special-purpose computer chips.

In one embodiment, the chip set or chip 1400 includes merely one or more processors and some software and/or firmware supporting and/or relating to and/or for the one or more processors.

The processor 1403 and accompanying components have connectivity to the memory 1405 via the bus 1401. The memory 1405 includes both dynamic memory (e.g., RAM, magnetic disk, writable optical disk, etc.) and static memory (e.g., ROM, CD-ROM, etc.) for storing executable instructions that when executed perform the inventive steps described herein to cause a presentation of one or more segments of routing information in multiple user interface elements of a user interface for user selection, and causing an update of the multiple user interface elements based on the selection. The memory 1405 also stores the data associated with or generated by the execution of the inventive steps.

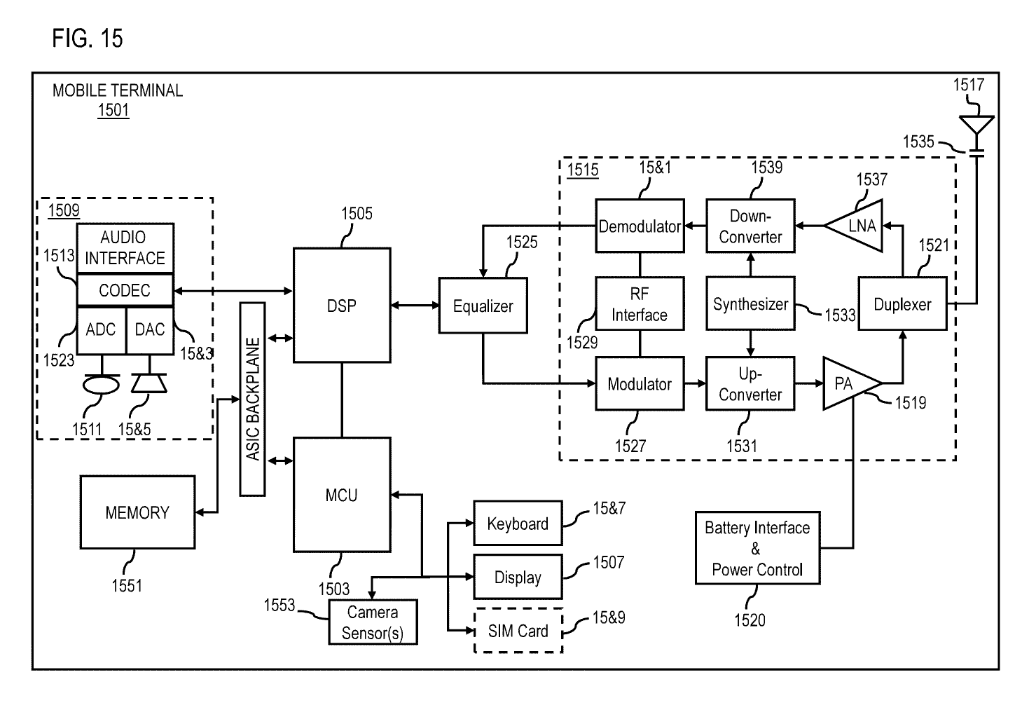

FIG. 15 is a diagram of exemplary components of a mobile terminal (e.g., handset) for communications, which is capable of operating in the system of FIG. 1, according to one embodiment. In some embodiments, mobile terminal 1501, or a portion thereof, constitutes a means for performing one or more steps of causing a presentation of one or more segments of routing information in multiple user interface elements of a user interface for user selection, and causing an update of the multiple user interface elements based on the selection. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 1503, a Digital Signal Processor (DSP) 1505, and a receiver/transmitter unit including a microphone gain control unit and a speaker gain control unit. A main display unit 1507 provides a display to the user in support of various applications and mobile terminal functions that perform or support the steps of causing a presentation of one or more segments of routing information in multiple user interface elements of a user interface for user selection, and causing an update of the multiple user interface elements based on the selection. The display 1507 includes display circuitry configured to display at least a portion of a user interface of the mobile terminal (e.g., mobile telephone). Additionally, the display 1507 and display circuitry are configured to facilitate user control of at least some functions of the mobile terminal. An audio function circuitry 1509 includes a microphone 1511 and microphone amplifier that amplifies the speech signal output from the microphone 1511. The amplified speech signal output from the microphone 1511 is fed to a coder/decoder (CODEC) 1513.

A radio section 1515 amplifies power and converts frequency in order to communicate with a base station, which is included in a mobile communication system, via antenna 1517. The power amplifier (PA) 1519 and the transmitter/modulation circuitry are operationally responsive to the MCU 1503, with an output from the PA 1519 coupled to the duplexer 1521 or circulator or antenna switch, as known in the art. The PA 1519 also couples to a battery interface and power control unit 1520.

In use, a user of mobile terminal 1501 speaks into the microphone 1511 and his or her voice along with any detected background noise is converted into an analog voltage. The analog voltage is then converted into a digital signal through the Analog to Digital Converter (ADC) 1523. The control unit 1503 routes the digital signal into the DSP 1505 for processing therein, such as speech encoding, channel encoding, encrypting, and interleaving. In one embodiment, the processed voice signals are encoded, by units not separately shown, using a cellular transmission protocol such as enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like, or any combination thereof.

The encoded signals are then routed to an equalizer 1525 for compensation of any frequency-dependent impairments that occur during transmission though the air such as phase and amplitude distortion. After equalizing the bit stream, the modulator 1527 combines the signal with a RF signal generated in the RF interface 1529. The modulator 1527 generates a sine wave by way of frequency or phase modulation. In order to prepare the signal for transmission, an up-converter 1531 combines the sine wave output from the modulator 1527 with another sine wave generated by a synthesizer 1533 to achieve the desired frequency of transmission. The signal is then sent through a PA 1519 to increase the signal to an appropriate power level. In practical systems, the PA 1519 acts as a variable gain amplifier whose gain is controlled by the DSP 1505 from information received from a network base station. The signal is then filtered within the duplexer 1521 and optionally sent to an antenna coupler 1535 to match impedances to provide maximum power transfer. Finally, the signal is transmitted via antenna 1517 to a local base station. An automatic gain control (AGC) can be supplied to control the gain of the final stages of the receiver. The signals may be forwarded from there to a remote telephone which may be another cellular telephone, any other mobile phone or a land-line connected to a Public Switched Telephone Network (PSTN), or other telephony networks.

Voice signals transmitted to the mobile terminal 1501 are received via antenna 1517 and immediately amplified by a low noise amplifier (LNA) 1537. A down-converter 1539 lowers the carrier frequency while the demodulator 1541 strips away the RF leaving only a digital bit stream. The signal then goes through the equalizer 1525 and is processed by the DSP 1505. A Digital to Analog Converter (DAC) 1543 converts the signal and the resulting output is transmitted to the user through the speaker 1545, all under control of a Main Control Unit (MCU) 1503 which can be implemented as a Central Processing Unit (CPU).

The MCU 1503 receives various signals including input signals from the keyboard 1547. The keyboard 1547 and/or the MCU 1503 in combination with other user input components (e.g., the microphone 1511) comprise a user interface circuitry for managing user input. The MCU 1503 runs a user interface software to facilitate user control of at least some functions of the mobile terminal 1501 to cause a presentation of one or more segments of routing information in multiple user interface elements of a user interface for user selection, and causing an update of the multiple user interface elements based on the selection. The MCU 1503 also delivers a display command and a switch command to the display 1507 and to the speech output switching controller, respectively. Further, the MCU 1503 exchanges information with the DSP 1505 and can access an optionally incorporated SIM card 1549 and a memory 1551. In addition, the MCU 1503 executes various control functions required of the terminal. The DSP 1505 may, depending upon the implementation, perform any of a variety of conventional digital processing functions on the voice signals. Additionally, DSP 1505 determines the background noise level of the local environment from the signals detected by microphone 1511 and sets the gain of microphone 1511 to a level selected to compensate for the natural tendency of the user of the mobile terminal 1501.

The CODEC 1513 includes the ADC 1523 and DAC 1543. The memory 1551 stores various data including call incoming tone data and is capable of storing other data including music data received via, e.g., the global Internet. The software module could reside in RAM memory, flash memory, registers, or any other form of writable storage medium known in the art. The memory device 1551 may be, but not limited to, a single memory, CD, DVD, ROM, RAM, EEPROM, optical storage, magnetic disk storage, flash memory storage, or any other non-volatile storage medium capable of storing digital data.

An optionally incorporated SIM card 1549 carries, for instance, important information, such as the cellular phone number, the carrier supplying service, subscription details, and security information. The SIM card 1549 serves primarily to identify the mobile terminal 1501 on a radio network. The card 1549 also contains a memory for storing a personal telephone number registry, text messages, and user specific mobile terminal settings.

Further, one or more camera sensors 1553 may be incorporated onto the mobile station 1501 wherein the one or more camera sensors may be placed at one or more locations on the mobile station. Generally, the camera sensors may be utilized to capture, record, and cause to store one or more still and/or moving images (e.g., videos, movies, etc.) which also may comprise audio recordings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

1. A method comprising facilitating a processing of and/or processing (1) data and/or (2) information and/or (3) at least one signal, the (1) data and/or (2) information and/or (3) at least one signal based, at least in part, on the following:
a presentation of a first representation of one or more segments of routing information in at least one first user interface element of a user interface;
a presentation of a second representation of the one or more segments of routing information in at least one second user interface element of the user interface;
at least one determination of one or more interactions with the at least one first user interface element to cause, at least in part, a presentation of one or more other segments of the routing information; and
an updating of the at least one second user interface element based, at least in part, on the presentation of the one or more other segments of the routing information.

2. A method of claim 1, wherein the at least one user interface element, the at least one second user interface, or a combination thereof is a sub-window of the user interface element.

3. A method of claim 1, wherein the first representation, the second representation, or a combination thereof include, at least in part, a map representation, a text-based representation, a multi-media representation, or combination thereof.

4. A method of claim 1, wherein the (1) data and/or (2) information and/or (3) at least one signal are further based, at least in part, on the following:
at least one determination of a position of at least one device to cause, at least in part, a presentation of time-based information for at least one segment of routing information, at least one travel comprising plurality of segments of routing information, or a combination thereof.

5. A method of claim 1, wherein the (1) data and/or (2) information and/or (3) at least one signal are further based, at least in part, on the following:
a presentation of one or more visual guidance information for identifying one or more segments of routing information; and
a highlighting of at least one segment of routing information to notify at least one user that the particular segment of routing information is being utilized.

6. A method of claim 1, wherein the (1) data and/or (2) information and/or (3) at least one signal are further based, at least in part, on the following:
at least one determination of a position of at least one device, wherein the position is displayed in at least one first user interface element, at least one second user interface element, or a combination thereof;
at least one determination of a change in the location information, the change causing a transition from one segment of routing information to another segment of routing information; and
a presentation of the updated segment of routing information in at least one first user interface element, at least one second user interface element, or a combination thereof.

7. A method of claim 1, wherein determining the one or more interactions with the at least one first user interface element comprises determining one or more swiping user actions on the at least one first user interface element.

8. A method of claim 3, wherein the (1) data and/or (2) information and/or (3) at least one signal are further based, at least in part, on the following:
a transition from one segment of routing information to another segment of routing information based, at least in part, on the one or more interactions,
wherein one or more interactions with at least one first user interface element causes panning of the map representation in the at least one second user interface element.

9. A method of claim 1, wherein the (1) data and/or (2) information and/or (3) at least one signal are further based, at least in part, on the following:
a notification based, at least in part, on a determination that at least one user has reached at least one segment of routing information,
wherein at least one notification include, textual alert, audio alert, vibration, or a combination thereof.

10. A method of claim 1, wherein one or more segments of routing information includes walking directions, driving directions, transit directions, bicycling directions, or a combination thereof.

11. An apparatus comprising:
at least one processor; and
at least one memory including computer program code for one or more programs,
the at least one memory and the computer program code configured to, with the at least one processor, cause the apparatus to perform at least the following,
cause, at least in part, a presentation of a first representation of one or more segments of routing information in at least one first user interface element of a user interface;
cause, at least in part, a presentation of a second representation of the one or more segments of routing information in at least one second user interface element of the user interface;
determine one or more interactions with the at least one first user interface element to cause, at least in part, a presentation of one or more other segments of the routing information; and
cause, at least in part, an updating of the at least one second user interface element based, at least in part, on the presentation of the one or more other segments of the routing information.

12. An apparatus of claim 11, wherein the at least one user interface element, the at least one second user interface, or a combination thereof is a sub-window of the user interface element.

13. An apparatus of claim 11, wherein the first representation, the second representation, or a combination thereof include, at least in part, a map representation, a text-based representation, a multi-media representation, or combination thereof.

14. An apparatus of claim 11, wherein the apparatus is further caused to:
determine a position of at least one device to cause, at least in part, a presentation of time-based information for at least one segment of routing information, at least one travel comprising plurality of segments of routing information, or a combination thereof.

15. An apparatus of claim 11, wherein the apparatus is further caused to:
cause, at least in part, a presentation of one or more visual guidance information for identifying one or more segments of routing information; and
cause, at least in part, a highlighting of at least one segment of routing information to notify at least one user that the particular segment of routing information is being utilized.

16. An apparatus of claim 11, wherein the apparatus is further caused to:
determine a position of at least one device, wherein the position is displayed in at least one first user interface element, at least one second user interface element, or a combination thereof;
determine a change in the location information, the change causing a transition from one segment of routing information to another segment of routing information; and
cause, at least in part, a presentation of the updated segment of routing information in at least one first user interface element, at least one second user interface element, or a combination thereof.

17. An apparatus of claim 11, wherein determining the one or more interactions with the at least one first user interface element comprises determining one or more swiping user actions on the at least one first user interface element.

18. An apparatus of claim 13, wherein the apparatus is further caused to:
cause, at least in part, a transition from one segment of routing information to another segment of routing information based, at least in part, on the one or more interactions,
wherein one or more interactions with at least one first user interface element causes panning of the map representation in the at least one second user interface element.

19. An apparatus of claim 11, wherein the apparatus is further caused to:
cause, at least in part, a notification based, at least in part, on a determination that at least one user has reached at least one segment of routing information,
wherein at least one notification include, textual alert, audio alert, vibration, or a combination thereof.

20. An apparatus of claim 11, wherein one or more segments of routing information includes walking directions, driving directions, transit directions, bicycling directions, or a combination thereof.

21.-48. (canceled)
